(19) United States
(12) Patent Application Publication
(10) Pub. No.: US 2018/0033091 A1
(43) Pub. Date: Feb. 1, 2018

(54) METHOD AND SYSTEM FOR INTEGRATING INVOICE RELATED FINANCIAL TRANSACTION DATA INTO A PERSONAL FINANCIAL MANAGEMENT AND BILL PAYMENT SYSTEM TO MORE ACCURATELY IDENTIFY AND CATEGORIZE TAX RELATED FINANCIAL TRANSACTIONS

(71) Applicant: Intuit Inc., Mountain View, CA (US)

(72) Inventors: Elangovan Shanmugam, Cupertino, CA (US); Sean McCluskey, Redwood City, CA (US); Jesse Aaron Axelowitz, San Francisco, CA (US); Ashwin Singh Khurana, Fremont, CA (US); Michael J. Seilnacht, Fremont, CA (US)

(73) Assignee: Intuit Inc., Mountain View, CA (US)

(21) Appl. No.: 15/220,602

(22) Filed: Jul. 27, 2016

(51) Int. Cl. G06Q 40/00

(52) U.S. Cl. CPC G06Q 40/123

(57) ABSTRACT

Invoice related financial transaction data is obtained and integrated into a personal financial management and bill payment system. The integrated invoice related financial transaction data is then analyzed to identify and extract additional invoice related financial transaction data, such as Level-3 financial transaction data, included in the invoice related financial transaction data. The additional invoice related financial transaction data is then used to more accurately and automatically identify tax related financial transactions for processing as tax related financial transactions having tax ramifications.

### RELATED APPLICATIONS/INCORPORATION BY REFERENCE

This application is related to U.S. patent application Ser. No. 15/140,117 (docket number INTU169676), filed on behalf of the same Inventors of the present patent application, filed on Apr. 27, 2016, entitled “METHOD AND SYSTEM FOR PROVIDING INVOICES GENERATED THROUGH A BUSINESS INVOICING SYSTEM TO A CUSTOMER USER OF A PERSONAL FINANCIAL MANAGEMENT AND BILL PAYMENT SYSTEM,” which is herein incorporated by reference in its entirety as if it were fully set forth herein.

This application is also related to U.S. patent application Ser. No. 15/140,131 (docket number INTU169677), filed on behalf of the same Inventors of the present patent application, filed on Apr. 27, 2016, entitled “METHOD AND SYSTEM FOR IDENTIFYING INVOICES THAT ARE PAID THROUGH A PERSONAL FINANCIAL MANAGEMENT AND BILL PAYMENT SYSTEM,” which is herein incorporated by reference in its entirety as if it were fully set forth herein.

This application is also related to U.S. patent application Ser. No. 15/142,708 (docket number INTU169678), filed on behalf of the same Inventors of the present patent application, filed on Apr. 29, 2016, entitled “METHOD AND SYSTEM FOR INTEGRATING BUSINESS INVOICES INTO A PERSONAL FINANCIAL MANAGEMENT AND BILL PAYMENT SYSTEM,” which is herein incorporated by reference in its entirety as if it were fully set forth herein.

### BACKGROUND

Currently, several personal financial management and bill payment systems are available to help a personal financial management and bill payment system user, or any authorized party acting on behalf of a personal financial management and bill payment system user, obtain financial transaction data representing financial transactions conducted by the user, process/analyze the financial transaction data, display categorized financial transaction data, generate financial transaction reports, generate bills due and payments due reports, and/or make manual, semi-automated, and/or automatic bill payments through the personal financial management and bill payment system.

Some personal financial management and bill payment systems help users manage their finances and/or track their expenditures/financial transactions by providing a centralized interface with banks, credit card companies, and various other financial institutions, for electronically obtaining, identifying, and/or categorizing the user's financial transaction data.

Currently, personal financial management and bill payment systems typically obtain electronic financial transaction data, such as payee data, payment amount data, transaction date data, etc. via communication with banks, credit card providers, or other financial institutions, using electronic data transfer systems, or various other systems for obtaining/transferring financial transaction data.

Once personal financial management and bill payment systems obtain financial transaction data, the financial transaction data is typically categorized into one of more financial transaction categories such as, business expenses, home expenses, home repair expenses, automotive expenses, entertainment expenses, groceries, dinning out, clothing, rent, mortgage, tax related/tax ramification related expenses, etc. This categorized financial transaction data is then processed to generate financial transaction reports, spending analysis reports, generate budget data and/or budget guideline reports, generate comparisons and/or peer based standing reports, identify and generate bills due and payments due reports, and/or make manual, semi-automated, and/or automatic bill payments through the personal financial management and bill payment system. Consequently, the ability to obtain and generate categorized financial transaction data is a central capability to virtually all personal financial management and bill payment systems and features.

In addition, it has been empirically shown that one of the most critical issues related to obtaining and/or keeping users of a personal financial management and bill payment system is minimizing the amount of data the user must manually enter into the personal financial management and bill payment system.

Therefore, two potentially conflicting pressures are faced by currently available personal financial management and bill payment system providers: the need for accurate and detailed financial transaction categorization data, which could logically be provided by user data entry; and the need to minimize required user interaction, and particularly the need to minimize the amount of data the user must manually, or otherwise, provide.

To address this conflict, some personal financial management and bill payment systems implement automatic, and/or semi-automatic, financial transaction categorization features whereby the financial transaction data, such as payee data, payment amount data, transaction date data, etc. is processed and analyzed in an effort to automatically determine a financial category to be assigned to the financial transaction associated with the financial transaction data.

One particularly important financial transaction categorization/classification is that indicating a status of tax related financial transaction.

Herein, the term “tax related financial transaction” includes any financial transaction requesting and/or resulting in, a transfer or re-categorization of funds, that includes a transfer or re-categorization of funds that has potential tax ramifications to a user, i.e., has a potential for resulting in tax consequences for the user and/or to potentially cause a change in the user's tax liability. Examples of tax related financial transactions include, but are not limited to; invoices for home repair and/or home improvement work; invoices for child care; invoices associated with charitable donations and projects; invoices associated with healthcare; invoices associated with business automobile travel; invoices associated with business expenses; invoices associated with business travel; invoices associated with business related computing systems, office equipment, and/or office/business electronics; invoices for professional services related to a business; and/or any other invoices requesting and/or resulting in, a transfer or re-categorization of funds, that includes a transfer or re-categorization of funds that has potential tax ramifications to a user, i.e., has a potential for resulting in tax consequences for the user and/or to potentially cause a change in the user's tax liability.

Clearly, the ability to identify as many tax related financial transactions as possible would be of significant benefit to users of both personal financial management and bill payment systems and tax preparation and filing systems. However, currently, automatic, and/or semi-automatic, financial transaction categorization features, while helpful, are far from perfect mechanisms for identifying tax related financial transactions. This is true for several reasons.

First, the level of detail associated with much of the financial transaction data currently made available to personal financial management and bill payment systems is often inadequate for tax related financial transaction identification purposes. Currently, the only financial transaction data associated with a given financial transaction typically obtained/provided is, financial transaction date data, financial transaction amount data, and, hopefully, financial transaction payee data. However, this level of financial transaction detail often provides very little information of value when it comes to determining a tax related status for a given financial transaction.

As a specific illustrative example, financial transaction data indicating a payment of $200.00 made to a department store, such as Walmart™, on a given date reveals almost no usable tax related financial transaction identification guidance. The transaction could represent a purchase of tires (an automotive financial category expense which could also be a tax related financial transaction); office supplies (a business financial category expense and a potential tax related financial transaction); groceries (a food/groceries financial category expense, typically not a potential tax related financial transaction); an appliance (a home financial category expense which could also be a tax related financial transaction); house paint (a home improvement financial category expense, typically not a potential tax related financial transaction); or any other type of purchase, and/or any combination of non-potential tax related financial transaction and potential tax related financial transaction related purchases. Consequently, in this illustrative example, without further data input from the user, typically manually entered, the $200.00 transaction can't be accurately categorized and/or processed as either a non-potential tax related financial transaction or a potential tax related financial transaction.

As seen above, the lack of detail in the financial transaction data associated with many financial transactions can not only result in an inability to identify potential tax related financial transactions, but it can also result in erroneous categorization of financial transactions as potential tax related financial transactions, and/or non-potential tax related financial transactions. This is particularly problematic because correcting erroneous categorization of financial transactions as potential tax related financial transactions, and/or non-potential tax related financial transactions, often requires more processing, and even more user input, than simply obtaining the data from the user in the first place.

In addition, in order to obtain the most benefit from a personal financial management and bill payment system, receive the most accurate and useful reports, and most accurately automatically determine categorization of future financial transactions as potential tax related financial transactions as possible, it is critical that as much financial transaction data, including all payment due and payment made related financial transaction data, bill payment related financial transaction data, and invoice related financial transaction data, associated with the user of the personal financial management and bill payment system be obtained by, or provided to, the personal financial management and bill payment system. This is because not only does the accuracy of the automatic categorization of both current and future financial transaction as potential tax related financial transactions, and/or non-potential tax related financial transactions, increase when more financial transaction data is processed, but most reports generated by the personal financial management and bill payment system for the user are only accurate, and/or useful, if the vast majority, if not all, the financial transactions associated with the user are identified and processed.

Despite this fact, businesses are currently typically unable to access personal financial management and bill payment systems used by their customers and provide invoices to their customers through the personal financial management and bill payment systems used by their customers. In addition, currently available personal financial management and bill payment systems do not provide a mechanism for automatically obtaining, identifying, or distinguishing, invoices, invoice related financial transaction data, and/or invoice payments from bill payment data and then properly processing and integrating identified invoice related financial transaction data into the personal financial management and bill payment system.

As used herein, the term “bill” includes, but is not limited to, an account statement or other potentially recurring cost and financial transaction. Currently, bill payments due are represented in personal financial management and bill payment system payment due data. Examples of bills include, but are not limited to: rent payments, utility payments, credit card payments, mortgage payments, vehicle loan payments, etc. Bills are typically associated with larger, well known, and/or nationally or regionally known, payee businesses.

In contrast to the term “bill,” herein the term “invoice” includes, but is not limited to, documents/data associated with a specific product and/or service provided by a business and for which full payment is typically requested via a discrete invoice statement. A given discrete invoice is therefore typically a non-recurring expense and/or is associated with specific products and/or services rendered, even though multiple, and even recurring identical, invoices can be generated by the same payee business for the same payor customer if multiple products and/or services, and/or the same products and/or services, are provided. Invoices are typically associated with smaller, regional or local, payee businesses than those associated with bills. Herein the term “invoice related financial transaction data” includes data representing all, or part of, an “invoice.”

Herein the terms “payment,” and/or “payment due,” and/or “payment due items” are used interchangeably and include any payment owed, or made, by a first party, i.e., payor party, to a second party, i.e., a payee party. Consequently, as used herein, the terms “payment” and/or “payment due” can include both “bills” and “invoices.”

In addition, as used herein, the term “financial transaction data” can include data associated with any financial transaction conducted by, or on behalf of, a user of a personal financial management and bill payment system. Consequently, as used herein the term “financial transaction data” includes, but is not limited to: bill related financial transaction data; invoice related financial transaction data; and any other personal financial management and bill payment system payment data representing payment due items to be paid through the personal financial management and bill payment system.

Herein, the term “tax related financial transaction” includes any financial transaction, i.e., requesting and/or resulting in, a transfer or re-categorization of funds, that includes a transfer or re-categorization of funds that has potential tax ramifications to a user, i.e., has a potential for resulting in tax consequences for the user and/or to potentially cause a change in the user's tax liability. Examples of tax related financial transactions include, but are not limited to; invoices for home repair and/or home improvement work; invoices for child care; invoices associated with charitable donations and projects; invoices associated with healthcare; invoices associated with business automobile travel; invoices associated with business expenses; invoices associated with business travel; invoices associated with business related computing systems, office equipment, and/or office/business electronics; invoices for professional services related to a business; invoices for office supplies; and/or any other invoices requesting and/or resulting in, a transfer or re-categorization of funds, that includes a transfer or re-categorization of funds that has potential tax ramifications to a user, i.e., has a potential for resulting in tax consequences for the user and/or to potentially cause a change in the user's tax liability.

Given that, as noted above, it is critical that as much financial transaction data associated with the user of the personal financial management and bill payment system be obtained by, or provided to, the personal financial management and bill payment system as possible, the inability of currently available personal financial management and bill payment systems to provide a mechanism for automatically obtaining, identifying, or distinguishing, invoices, invoice related financial transaction data, and/or invoice payments from bill payment data and then properly processing and integrating identified invoice related financial transaction data into the personal financial management and bill payment system is clearly a long standing technical problem in the financial management arts. However, the situation is even worse because invoice related financial transaction data often includes very detailed additional invoice related financial transaction data, including financial transaction data known in the art as “Level-3” financial transaction data that can help identify tax related financial transactions.

Level-3 financial transaction data includes data indicating not only the payee, payor, amount, and date of the financial transaction, but also line item listing data representing the item actually purchased, and the amount paid for each item listed. Specific examples/fields of Level-3 data include, but are not limited to: Quantity data; Item ID or SKU; Item description; Unit price; Extended price; Unit of measure (each); Commodity code; Line discount; Ship-From Zip Code; Destination Zip Code; Invoice Number; Item Extended Amount; Freight Amount; Duty Amount, etc. Consequently, Level-3 data is the most desired and informative/useful type of financial transaction data, particularly for identifying tax related financial transactions.

However, absent invoice related financial transaction data, Level-3 data is often difficult to obtain and often requires special equipment and permissions. For instance, historically, when Level-3 data is obtained from traditional sources, such as credit card financial transactions and bill payments, there have been significant obstacles for businesses wanting to provide and/or obtain Level-3 data. The most obvious is that card terminals do not typically prompt for the additional financial transaction related data, and if they did, data would be manually entered from a numeric keypad. Consequently, businesses who want to obtain, supply, and process, Level-3 data need to input their transaction information from specialized point-of-sale software systems that prompt them for the required information.

As a result, most businesses will never have the opportunity to, and/or be willing or able to dedicate the resources to, obtain and/or accept Level-3 data in any traditional way. Therefore, invoice related financial transaction data represents a valuable opportunity to obtain Level-3 data in a potentially simple, efficient, and cost effective way, without requiring special processes, systems, equipment, and permissions.

In addition, invoice related financial transaction data often includes additional invoice related financial transaction data in the form of notes and other data from the payee business to the payor user, or vice versa. This invoice note related data is also a potentially valuable source of financial transaction detail data, and/or Level-3 data.

However, since businesses are currently unable to access personal financial management and bill payment systems used by their customers and provide invoices to their customers through the personal financial management and bill payment systems used by their customers, and currently available personal financial management and bill payment systems do not provide a mechanism for automatically obtaining, identifying, or distinguishing, invoices, invoice related financial transaction data, and/or invoice payments, or properly processing and integrating invoices into a personal financial management and bill payment system, this potentially valuable source of Level-3 data is currently not effectively and efficiently leveraged by personal financial management and bill payment systems to identify potential tax related financial transactions.

Therefore, there is also a long standing technical problem in the financial management system, payment processing, and invoicing arts in that businesses are currently unable to access personal financial management and bill payment systems used by their customers and provide invoices to their customers through the personal financial management and bill payment systems used by their customers. In addition, currently available personal financial management and bill payment systems do not provide a mechanism for automatically obtaining, identifying, or distinguishing, invoices, invoice data, and/or invoice payments and then properly processing and integrating identified invoices into a personal financial management and bill payment system.

Consequently, there is a long standing technical need in the tax preparation, payment processing, invoice processing, and financial management arts for a technical solution for automatically integrating invoice related financial transaction data into a personal financial management and bill payment system, and/or obtaining, identifying, or distinguishing, invoice related financial transaction data, processing the integrated invoice related financial transaction data to extract additional invoice related financial transaction data, such as Level-3 financial transaction data, included in the invoice related financial transaction data, and then using the additional invoice related financial transaction data to more accurately and automatically identify tax related financial transactions for processing as tax related financial transactions having tax ramifications.

### SUMMARY

In accordance with one embodiment, invoice related financial transaction data is obtained and integrated into a personal financial management and bill payment system. The integrated invoice related financial transaction data is then analyzed to identify and extract additional invoice related financial transaction data, such as Level-3 financial transaction data, included in the invoice related financial transaction data. The additional invoice related financial transaction data is then used to more accurately and automatically identify tax related financial transactions for processing as tax related financial transactions having tax ramifications.

Consequently, using the disclosed embodiments, additional invoice related financial transaction data, such as Level-3 financial transaction data, included in invoice related financial transaction data is leveraged to identify tax related financial transactions for processing as tax related financial transactions having tax ramifications.

Therefore, disclosed herein is a technical solution to the long standing technical need in the financial management and user experience arts for automatically integrating invoice related financial transaction data into a personal financial management and bill payment system, and/or obtaining, identifying, or distinguishing, invoice related financial transaction data, processing the integrated invoice related financial transaction data to extract additional invoice related financial transaction data, such as Level-3 financial transaction data, included in the invoice related financial transaction data, and then using the additional invoice related financial transaction data to more accurately and automatically identify tax related financial transactions for processing as tax related financial transactions having tax ramifications.

In accordance with one embodiment of a method and system for integrating invoice related financial transaction data into a personal financial management and bill payment system to more accurately identify and categorize tax related financial transactions, access to invoice related financial transaction data generated by the one or more payee businesses is obtained.

In one embodiment, the invoice related financial transaction data represents two or more discrete invoices submitted by one or more payee businesses requesting payment by one or more payor users of the personal financial management and bill payment system.

In one embodiment, the invoice related financial transaction data includes payee business identity data associated with each discrete invoice represented in the invoice related financial transaction data. In one embodiment, the payee business identity data represents the identity of the payee business associated with each discrete invoice represented in the invoice related financial transaction data.

In one embodiment, the invoice related financial transaction data also includes payor user identity data associated with each discrete invoice represented in the invoice related financial transaction data. In one embodiment, the payor user identity data represents the identity of the payor user associated with each discrete invoice represented in the invoice related financial transaction data.

In one embodiment, the invoice related financial transaction data further includes invoice amount data associated with each discrete invoice represented in the invoice related financial transaction data. In one embodiment, the invoice amount data represents the payment amount associated with each discrete invoice represented in the invoice related financial transaction data.

In one embodiment, the invoice related financial transaction data includes additional invoice related financial transaction data, such as but not limited to, Level-3 financial transaction data. In one embodiment, the additional invoice related financial transaction data is associated with at least one discrete invoice represented in the invoice related financial transaction data and provides additional transaction details, and/or information, associated with the at least one discrete invoice represented in the invoice related financial transaction data.

In accordance with one embodiment, the invoice related financial transaction data is integrated into personal financial management and bill payment system payment due data associated with a personal financial management and bill payment system. In one embodiment, the personal financial management and bill payment system payment due data represents one or more payments due associated with one or more users of the personal financial management and bill payment system as payment due items to be paid through the personal financial management and bill payment system.

In accordance with one embodiment, access to the personal financial management and bill payment system and the personal financial management and bill payment system payment due data, including the integrated invoice related financial transaction data, and the additional invoice related financial transaction data is obtained.

In accordance with one embodiment, the personal financial management and bill payment system and the personal financial management and bill payment system payment due data, including the integrated invoice related financial transaction data, and the additional invoice related financial transaction data is analyzed to identify a first discrete invoice represented in the invoice related financial transaction data that includes additional first invoice related financial transaction data associated with the first discrete invoice represented in the invoice related financial transaction data.

In accordance with one embodiment, the additional first invoice related financial transaction data is identified, extracted, and analyzed to determine if the first discrete invoice represented in the invoice related financial transaction data is a tax related invoice having potential tax ramifications.

In accordance with one embodiment, a determination is made that the first discrete invoice represented in the invoice related financial transaction data is a tax related invoice having potential tax ramifications.

In accordance with one embodiment, once a determination is made that the first discrete invoice represented in the invoice related financial transaction data is a tax related invoice having potential tax ramifications, first invoice status data associated with the first discrete invoice represented in the invoice related financial transaction data is transformed into tax related invoice status data.

In accordance with one embodiment, the portion of the invoice related financial transaction data representing the first discrete invoice is then processed as tax related invoice financial transaction data.

The disclosed embodiments provide an efficient, effective, and highly adaptable solution to the long standing technical need in the bill payment, invoice processing, tax preparation and filing, and financial management, arts for automatically integrating invoice related financial transaction data into a personal financial management and bill payment system, and/or obtaining, identifying, or distinguishing, invoice related financial transaction data, processing the integrated invoice related financial transaction data to extract additional invoice related financial transaction data, such as Level-3 financial transaction data, included in the invoice related financial transaction data, and then using the additional invoice related financial transaction data to more accurately and automatically identify tax related financial transactions for processing as tax related financial transactions having tax ramifications.

However, the disclosed method and system for integrating invoice related financial transaction data into a personal financial management and bill payment system to more accurately identify and categorize tax related financial transactions does not encompass, embody, or preclude other forms of innovation in the area of automated financial transaction bill payment, processing, and reporting, and/or tax preparation and filing. In addition, the disclosed method and system for integrating invoice related financial transaction data into a personal financial management and bill payment system to more accurately identify and categorize tax related financial transactions is not related to any fundamental economic practice, fundamental data processing practice, mental steps, or pen and paper based solution. In fact, the disclosed embodiments are directed to providing solutions to the relatively new problems associated with the automatic processing and display of electronic financial transaction data obtained from multiple sources, making electronic bill payments and determining tax liabilities, and the management and processing of large amounts of data, i.e., “big data.” Consequently, the disclosed method and system for integrating invoice related financial transaction data into a personal financial management and bill payment system to more accurately identify and categorize tax related financial transactions is not directed to, does not encompass, and is not merely, an abstract idea or concept.

In addition, the disclosed method and system for integrating invoice related financial transaction data into a personal financial management and bill payment system to more accurately identify and categorize tax related financial transactions provides for significant improvements to the technical fields of electronic transaction data processing, tax return preparation, invoice processing, financial transaction categorization, information dissemination, data processing, data management, data filtering and mining, automatic electronic bill payment, and user experience.

In addition, by allowing for the integration of invoices and invoice data into a personal financial management and bill payment system, the disclosed method and system for integrating invoice related financial transaction data into a personal financial management and bill payment system to more accurately identify and categorize tax related financial transactions helps users of the personal financial management and bill payment system identify and pay their invoices and taxes. This, in turn, helps avoid the reissuance and repeated transmission of payment and tax due reminders and for the entry, processing, and dissemination, of redundant invoice and tax data; thereby eliminating unnecessary data analysis before resources are allocated to processing, and/or correcting, redundant data and the redundant data is further transmitted/distributed.

In addition, the disclosed method and system for integrating invoice related financial transaction data into a personal financial management and bill payment system to more accurately identify and categorize tax related financial transactions provides for the entry, processing, and dissemination, of only relevant portions of tax related data; thereby eliminating unnecessary data analysis and correction before resources are allocated to processing, and/or correcting, faulty/irrelevant data, and/or the faulty/irrelevant data is further transmitted/distributed.

Consequently, using the disclosed method and system for integrating invoice related financial transaction data into a personal financial management and bill payment system to more accurately identify and categorize tax related financial transactions results in more efficient use of human and non-human resources, fewer processor cycles being utilized, reduced memory utilization, and less communications bandwidth being utilized to relay data to, and from, backend systems and client systems.

As a result, computing systems are transformed into faster, more efficient, and more effective computing systems by implementing the method and system for integrating invoice related financial transaction data into a personal financial management and bill payment system to more accurately identify and categorize tax related financial transactions.

### BRIEF DESCRIPTION OF THE DRAWINGS

FIG. 1 is a high level functionality-based block diagram of a hardware and production environment for integrating invoice related financial transaction data into a personal financial management and bill payment system to more accurately identify and categorize tax related financial transactions, in accordance with one embodiment; and

FIG. 2 is a flow chart representing one example of a generalized process for integrating invoice related financial transaction data into a personal financial management and bill payment system to more accurately identify and categorize tax related financial transactions, in accordance with one embodiment.

Common reference numerals are used throughout the FIG.s and the detailed description to indicate like elements. One skilled in the art will readily recognize that the above FIG.s are examples and that other architectures, modes of operation, orders of operation, and elements/functions can be provided and implemented without departing from the characteristics and features of the invention, as set forth in the claims.

### Term Definitions

Herein, the term “personal financial management and bill payment system” includes, but is not limited to, the following: computing system, desktop system, mobile system, and/or wearable device implemented, and/or online, and/or web-based, storage based, persistence based, personal financial transaction aggregation and/or processing systems, services, packages, programs, modules, or applications; computing system, desktop system, mobile system, and/or wearable device implemented, and/or online, and/or web-based, storage based, persistence based, personal financial management and budgeting systems, services, packages, programs, modules, or applications; computing system, desktop system, mobile system, and/or wearable device implemented, and/or online, and/or web-based, storage based, persistence based, personal data management systems, services, packages, programs, modules, or applications; computing system, desktop system, mobile system, and/or wearable device implemented, and/or online, and/or web-based, storage based, persistence based, personal accounting systems, services, packages, programs, modules, or applications; and various other personal electronic data management systems, services, packages, programs, modules, or applications, whether known at the time of filling, or as developed later.

Specific examples of personal financial management and bill payment systems include, but are not limited to the following: Mint™, available from Intuit, Inc. of Mountain View, Calif.; Mint Online™, available from Intuit, Inc. of Mountain View, Calif.; and/or various other software systems discussed herein, and/or known to those of skill in the art at the time of filing, and/or as developed after the time of filing.

Herein, the term “business invoicing system” includes, but is not limited to, any system through which a business can generate, and/or submit, and/or process invoices requesting payment for products and/or services provided by the business to customers of the business. Therefore, the term “business invoicing system” includes, but is not limited to, the following: computing system, desktop system, mobile system, and/or wearable device implemented, and/or online, and/or web-based, storage based, persistence based, business accounting and/or invoicing systems, services, packages, programs, modules, or applications; computing system, desktop system, mobile system, and/or wearable device implemented, and/or online, and/or web-based, storage based, persistence based, business financial transaction aggregation and/or processing systems, services, packages, programs, modules, or applications; computing system, desktop system, mobile system, and/or wearable device implemented, and/or online, and/or web-based, storage based, persistence based, business financial management and budgeting systems, services, packages, programs, modules, or applications; computing system, desktop system, mobile system, and/or wearable device implemented, and/or online, and/or web-based, storage based, persistence based, business management systems, services, packages, programs, modules, or applications; and various other business electronic data management systems, services, packages, programs, modules, or applications, whether known at the time of filling, or as developed later.

Specific examples of “business invoicing systems” include, but are not limited to, the following: QuickBooks™, available from Intuit, Inc. of Mountain View, Calif.; QuickBooks Online™, available from Intuit, Inc. of Mountain View, Calif.; QuickBooks Self-Employed™, available from Intuit, Inc. of Mountain View, Calif.; and/or various other software systems discussed herein, and/or known to those of skill in the art at the time of filing, and/or as developed after the time of filing.

Herein, the terms “tax preparation system,” “tax filing system,” “tax return preparation and filing system,” and “tax preparation and filing system,” are used interchangeably and include, but are not limited to, the following: computing system, desktop system, mobile system, and/or wearable device implemented, and/or online, and/or web-based, storage based, persistence based, tax preparation and filing and/or processing systems, services, packages, programs, modules, or applications; and various other tax preparation and filing systems, services, packages, programs, modules, or applications, used to process and/or facilitate the filing of electronic tax and/or hardcopy tax return documents, whether known at the time of filling, or as developed later.

Specific examples of personal financial management and bill payment systems include, but are not limited to TurboTax™ available from Intuit, Inc. of Mountain View, Calif.; TurboTax Online™ available from Intuit, Inc. of Mountain View, Calif.; and/or various other software systems discussed herein, and/or known to those of skill in the art at the time of filing, and/or as developed after the time of filing.

Herein, the terms “software system” and “software application” are used interchangeably and can be, but are not limited to, any data management system implemented on a computing system, accessed through one or more servers, accessed through a network, accessed through a cloud, and/or provided through any system or by any mechanism and/or process, as discussed herein, and/or as known in the art at the time of filing, and/or as developed after the time of filing, that gathers/obtains data, from one or more sources and/or has the capability to analyze at least part of the data.

As used herein, the terms “computing system,” “computing device,” and “computing entity,” include, but are not limited to, the following: a server computing system; a workstation; a desktop computing system; a mobile computing system, including, but not limited to, smart phones, portable devices, and/or devices worn or carried by a user; a database system or storage cluster; a virtual asset; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

In addition, as used herein, the terms “computing system” and “computing entity,” can denote, but are not limited to the following: systems made up of multiple virtual assets, server computing systems, workstations, desktop computing systems, mobile computing systems, database systems or storage clusters, switching systems, routers, hardware systems, communications systems, proxy systems, gateway systems, firewall systems, load balancing systems, or any devices that can be used to perform the processes and/or operations as described herein.

Herein, the terms “mobile computing system” and “mobile device” are used interchangeably and include, but are not limited to the following: a smart phone; a cellular phone; a digital wireless telephone; a tablet computing system; a notebook computing system; any portable computing system; a two-way pager; a Personal Digital Assistant (PDA); a media player; an Internet appliance; devices worn or carried by a user; or any other movable/mobile device and/or computing system that includes components that can execute all, or part, of any one of the processes and/or operations as described herein.

Herein, the term “production environment” includes the various components, or assets, used to deploy, implement, access, and use, a given software system as that software system is intended to be used. In various embodiments, production environments include multiple computing systems and/or assets that are combined, communicatively coupled, virtually and/or physically connected, and/or associated with one another, to provide the production environment implementing the application.

As specific illustrative examples, the assets making up a given production environment can include, but are not limited to, the following: one or more computing environments used to implement at least part of the software system in the production environment such as a data center, a cloud computing environment, a dedicated hosting environment, and/or one or more other computing environments in which one or more assets used by the application in the production environment are implemented; one or more computing systems or computing entities used to implement at least part of the software system in the production environment; one or more virtual assets used to implement at least part of the software system in the production environment; one or more supervisory or control systems, such as hypervisors, or other monitoring and management systems used to monitor and control assets and/or components of the production environment; one or more communications channels for sending and receiving data used to implement at least part of the software system in the production environment; one or more access control systems for limiting access to various components of the production environment, such as firewalls and gateways; one or more traffic and/or routing systems used to direct, control, and/or buffer data traffic to components of the production environment, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement at least part of the software system in the production environment; one or more databases used to store data in the production environment; one or more internal or external services used to implement at least part of the software system in the production environment; one or more backend systems, such as backend servers or other hardware used to process data and implement at least part of the software system in the production environment; one or more software modules/functions used to implement at least part of the software system in the production environment; and/or any other assets/components making up an actual production environment in which at least part of the software system is deployed, implemented, accessed, and run, e.g., operated, as discussed herein, and/or as known in the art at the time of filing, and/or as developed after the time of filing.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known, “trusted” environments or unknown, “untrusted” environments. Typically, trusted computing environments are those where the assets, infrastructure, communication and networking systems, and security systems associated with the computing systems and/or virtual assets making up the trusted computing environment, are either under the control of, or known to, a party.

In various embodiments, each computing environment includes allocated assets and virtual assets associated with, and controlled or used to create, and/or deploy, and/or operate at least part of the software system.

In various embodiments, one or more cloud computing environments are used to create, and/or deploy, and/or operate at least part of the software system that can be any form of cloud computing environment, such as, but not limited to, a public cloud; a private cloud; a virtual private network (VPN); a subnet; a Virtual Private Cloud (VPC); a sub-net or any security/communications grouping; or any other cloud-based infrastructure, sub-structure, or architecture, as discussed herein, and/or as known in the art at the time of filing, and/or as developed after the time of filing.

In many cases, a given software system or service may utilize, and interface with, multiple cloud computing environments, such as multiple VPCs, in the course of being created, and/or deployed, and/or operated.

As used herein, the term “virtual asset” includes any virtualized entity or resource, and/or virtualized part of an actual, or “bare metal” entity. In various embodiments, the virtual assets can be, but are not limited to, the following: virtual machines, virtual servers, and instances implemented in a cloud computing environment; databases associated with a cloud computing environment, and/or implemented in a cloud computing environment; services associated with, and/or delivered through, a cloud computing environment; communications systems used with, part of, or provided through a cloud computing environment; and/or any other virtualized assets and/or sub-systems of “bare metal” physical devices such as mobile devices, remote sensors, laptops, desktops, point-of-sale devices, etc., located within a data center, within a cloud computing environment, and/or any other physical or logical location, as discussed herein, and/or as known/available in the art at the time of filing, and/or as developed/made available after the time of filing.

In various embodiments, any, or all, of the assets making up a given production environment discussed herein, and/or as known in the art at the time of filing, and/or as developed after the time of filing can be implemented as one or more virtual assets.

In one embodiment, two or more assets, such as computing systems and/or virtual assets, and/or two or more computing environments are connected by one or more communications channels including but not limited to, Secure Sockets Layer (SSL) communications channels and various other secure communications channels, and/or distributed computing system networks, such as, but not limited to the following: a public cloud; a private cloud; a virtual private network (VPN); a subnet; any general network, communications network, or general network/communications network system; a combination of different network types; a public network; a private network; a satellite network; a cable network; or any other network capable of allowing communication between two or more assets, computing systems, and/or virtual assets, as discussed herein, and/or available or known at the time of filing, and/or as developed after the time of filing.

As used herein, the term “network” includes, but is not limited to, any network or network system such as, but not limited to, the following: a peer-to-peer network; a hybrid peer-to-peer network; a Local Area Network (LAN); a Wide Area Network (WAN); a public network, such as the Internet; a private network; a cellular network; any general network, communications network, or general network/communications network system; a wireless network; a wired network; a wireless and wired combination network; a satellite network; a cable network; any combination of different network types; or any other system capable of allowing communication between two or more assets, virtual assets, and/or computing systems, whether available or known at the time of filing or as later developed.

Herein, the term “party,” “user,” “user consumer,” and “customer” are used interchangeably to denote any party and/or entity that interfaces with, and/or to whom information is provided by, the method and system for integrating invoice related financial transaction data into a personal financial management and bill payment system to more accurately identify and categorize tax related financial transactions described herein, and/or a person and/or entity that interfaces with, and/or to whom information is provided by, the method and system for integrating invoice related financial transaction data into a personal financial management and bill payment system to more accurately identify and categorize tax related financial transactions described herein, and/or a legal guardian of person and/or entity that interfaces with, and/or to whom information is provided by, the method and system for integrating invoice related financial transaction data into a personal financial management and bill payment system to more accurately identify and categorize tax related financial transactions described herein, and/or an authorized agent of any party and/or person and/or entity that interfaces with, and/or to whom information is provided by, the method and system for integrating invoice related financial transaction data into a personal financial management and bill payment system to more accurately identify and categorize tax related financial transactions described herein. For instance, in various embodiments, a user can be, but is not limited to, a person, a commercial entity, an application, a service, and/or a computing system.

Herein, the term “financial transaction” includes, but is not limited to, any interaction between two or more parties involving the transfer, or re-categorization, of funds between the parties. Herein, the term “financial transaction data” includes, but is not limited to, electronic data representing at least one financial transaction and that is capable of being processed by a processor, and/or stored in a memory, and/or is otherwise machine readable.

Herein, the term “product and/or service provider” includes any party and/or entity that is associated with a user through a financial transaction represented by financial transaction data.

As used herein, the term “bill” includes, but is not limited to, an account statement or other potentially recurring cost and financial transaction. Currently, bill payments due are represented in personal financial management and bill payment system payment due data. Examples of bills include, but are not limited to: rent payments, utility payments, credit card payments, mortgage payments, vehicle loan payments, etc. Bills are typically associated with larger, well known, and/or nationally or regionally known, payee businesses.

In contrast to the term “bill”, herein the term “invoice” includes, but is not limited to, documents/data associated with a specific product and/or service provided by a business and for which full payment is typically requested via a discrete invoice statement. Herein the term “invoice related financial transaction data” includes data representing all, or part of, an “invoice.” A given discrete invoice is therefore typically a non-recurring expense and/or is associated with specific products and/or services rendered, even though multiple, and even recurring identical, invoices can be generated by the same payee business for the same payor customer if multiple products and/or services, and/or the same products and/or services, are provided. Invoices are typically associated with smaller, regional or local, payee businesses than those associated with bills.

Herein the terms “payment,” and/or “payment due,” and/or “payment due items” are used interchangeably and include any payment owed, or made, by a first party, i.e., payor party, to a second party, i.e., a payee party. Consequently, as used herein, the terms “payment” and/or “payment due” include both “bills” and “invoices.”

As used herein, the term “financial transaction data” can include data associated with any financial transaction conducted by, or on behalf of, a user of a personal financial management and bill payment system. Consequently, as used herein the term “financial transaction data” includes, but is not limited to: bill related financial transaction data; invoice related financial transaction data; and any other personal financial management and bill payment system payment data representing payment due items to be paid through the personal financial management and bill payment system.

Herein the term “invoice related financial transaction data” includes data representing all, or part of, an “invoice.”

As used herein, the term “payor user” includes any user of a personal financial management and bill payment system associated with an invoice included in invoice related financial transaction data and to whom the invoice related financial transaction data is directed by a payee business.

As used herein, the term “payee business” includes any party or entity associated with an invoice included in invoice related financial transaction data and to whom the invoice amount associated with in invoice represented in invoice related financial transaction data is owed by a payor user.

Herein, the term “tax related invoice” includes any invoice associated with a financial transaction, i.e., requesting and/or resulting in, a transfer or re-categorization of funds, that includes a transfer or re-categorization of funds that has potential tax ramifications to a user, i.e., has a potential for resulting in tax consequences for the user and/or to potentially cause a change in the user's tax liability. Examples of tax related invoices include, but are not limited to; invoices for home repair and/or home improvement work; invoices for child care; invoices associated with charitable donations and projects; invoices associated with healthcare; invoices associated with business automobile travel; invoices associated with business expenses; invoices associated with business travel; invoices associated with business related computing systems, office equipment, and/or office/business electronics; invoices for professional services related to a business; and/or any other invoices requesting and/or resulting in, a transfer or re-categorization of funds, that includes a transfer or re-categorization of funds that has potential tax ramifications to a user, i.e., has a potential for resulting in tax consequences for the user and/or to potentially cause a change in the user's tax liability.

Herein, the term “tax related financial transaction” includes any financial transaction, i.e., requesting and/or resulting in, a transfer or re-categorization of funds, that includes a transfer or re-categorization of funds that has potential tax ramifications to a user, i.e., has a potential for resulting in tax consequences for the user and/or to potentially cause a change in the user's tax liability. Examples of tax related financial transactions include, but are not limited to; invoices for home repair and/or home improvement work; invoices for child care; invoices associated with charitable donations and projects; invoices associated with healthcare; invoices associated with business automobile travel; invoices associated with business expenses; invoices associated with business travel; invoices associated with business related computing systems, office equipment, and/or office/business electronics; invoices for professional services related to a business; and/or any other invoices requesting and/or resulting in, a transfer or re-categorization of funds, that includes a transfer or re-categorization of funds that has potential tax ramifications to a user, i.e., has a potential for resulting in tax consequences for the user and/or to potentially cause a change in the user's tax liability.

### DETAILED DISCLOSURE

Embodiments will now be discussed with reference to the accompanying FIG.s, which depict one or more exemplary embodiments. Embodiments may be implemented in many different forms and should not be construed as limited to the embodiments set forth herein, shown in the FIG.s, and/or described below. Rather, these exemplary embodiments are provided to allow a complete disclosure that conveys the principles of the invention, as set forth in the claims, to those of skill in the art.

In accordance with one embodiment of a method and system for integrating invoice related financial transaction data into a personal financial management and bill payment system to more accurately identify and categorize tax related financial transactions, access to invoice related financial transaction data generated by the one or more payee businesses is obtained.

In one embodiment, the obtained invoice related financial transaction data represents two or more discrete invoices submitted by one or more payee businesses requesting payment by one or more payor users of the personal financial management and bill payment system.

In one embodiment, the invoice related financial transaction data includes payee business identity data associated with each discrete invoice represented in the invoice related financial transaction data. In one embodiment, the payee business identity data represents the identity of the payee business associated with each discrete invoice represented in the invoice related financial transaction data.

In one embodiment, the invoice related financial transaction data also includes payor user identity data associated with each discrete invoice represented in the invoice related financial transaction data. In one embodiment, the payor user identity data represents the identity of the payor user associated with each discrete invoice represented in the invoice related financial transaction data.

In one embodiment, the invoice related financial transaction data further includes invoice amount data associated with each discrete invoice represented in the invoice related financial transaction data. In one embodiment, the invoice amount data represents the payment amount associated with each discrete invoice represented in the invoice related financial transaction data.

In one embodiment, the invoice related financial transaction data includes additional invoice related financial transaction data, such as but not limited to, Level-3 financial transaction data. In one embodiment, the additional invoice related financial transaction data is associated with at least one discrete invoice represented in the invoice related financial transaction data and provides additional transaction details, and/or information, associated with at least one discrete invoice represented in the invoice related financial transaction data.

In accordance with one embodiment, the invoice related financial transaction data generated by the one or more payee businesses is obtained from a business invoicing system provided to business users of the business invoicing system.

As noted above, herein, the term “business invoicing system” includes, but is not limited to, any system through which a business can generate, and/or submit, and/or process invoices requesting payment for products and/or services provided by the business to customers of the business. Therefore, the term “business invoicing system” includes, but is not limited to, the following: computing system, desktop system, mobile system, and/or wearable device implemented, and/or online, and/or web-based, storage based, persistence based, business accounting and/or invoicing systems, services, packages, programs, modules, or applications; computing system, desktop system, mobile system, and/or wearable device implemented, and/or online, and/or web-based, storage based, persistence based, business financial transaction aggregation and/or processing systems, services, packages, programs, modules, or applications; computing system, desktop system, mobile system, and/or wearable device implemented, and/or online, and/or web-based, storage based, persistence based, business financial management and budgeting systems, services, packages, programs, modules, or applications; computing system, desktop system, mobile system, and/or wearable device implemented, and/or online, and/or web-based, storage based, persistence based, business management systems, services, packages, programs, modules, or applications; and various other business electronic data management systems, services, packages, programs, modules, or applications, whether known at the time of filling, or as developed later.

Specific examples of “business invoicing systems” include, but are not limited to, the following: QuickBooks™, available from Intuit, Inc. of Mountain View, Calif.; QuickBooks Online™, available from Intuit, Inc. of Mountain View, Calif.; QuickBooks Self-Employed™, available from Intuit, Inc. of Mountain View, Calif.; and/or various other software systems discussed herein, and/or known to those of skill in the art at the time of filing, and/or as developed after the time of filing.

In some embodiments, the business invoicing system is part of, and/or a feature of, a parent small business financial management system.

In one embodiment, a personal financial management and bill payment system is provided using one or more computing systems.

As noted above, herein, the term “personal financial management and bill payment system” includes, but is not limited to, the following: computing system, desktop system, mobile system, and/or wearable device implemented, and/or online, and/or web-based, storage based, persistence based, personal financial transaction aggregation and/or processing systems, services, packages, programs, modules, or applications; computing system, desktop system, mobile system, and/or wearable device implemented, and/or online, and/or web-based, storage based, persistence based, personal financial management and budgeting systems, services, packages, programs, modules, or applications; computing system, desktop system, mobile system, and/or wearable device implemented, and/or online, and/or web-based, storage based, persistence based, personal data management systems, services, packages, programs, modules, or applications; computing system, desktop system, mobile system, and/or wearable device implemented, and/or online, and/or web-based, storage based, persistence based, personal accounting systems, services, packages, programs, modules, or applications; and various other personal electronic data management systems, services, packages, programs, modules, or applications, whether known at the time of filling, or as developed later.

As noted above, specific examples of personal financial management and bill payment systems include, but are not limited to the following: Mint™, available from Intuit, Inc. of Mountain View, Calif.; Mint Online™, available from Intuit, Inc. of Mountain View, Calif.; and/or various other software systems discussed herein, and/or known to those of skill in the art at the time of filing, and/or as developed after the time of filing.

Currently, personal financial management and bill payment systems and business invoicing systems are typically distinct software systems operated and/or used by two distinct parties, e.g., a customer of a business and an owner of a business, respectively. Therefore, currently, personal financial management and bill payment systems and business invoicing systems typically operate in isolation from each other, even when they are offered by the same personal financial management and bill payment system and business invoicing system provider.

As a specific illustrative example, in one embodiment, the personal financial management and bill payment system used by a customer of a business, or other user, could be a personal financial transaction management system such as Mint™, available from Intuit, Inc. of Mountain View, Calif. In this specific illustrative example, a business invoicing system, used by a business user, could be a business invoicing system such as QuickBooks™, available from Intuit, Inc. of Mountain View, Calif. As seen in this specific illustrative example, both the personal financial management and bill payment system and the business invoicing system are offered by the same software system provider, i.e., in this specific case, Intuit, Inc. of Mountain View, Calif.

Consequently, according to one embodiment, in this specific illustrative example, the personal financial management and bill payment system and the business invoicing system are provided the opportunity to share, “cross-pollinate,” and cross-confirm supported data. This approach has several unique advantages.

In accordance with one embodiment, one or more processors associated with one or more computing systems are utilized to obtain access to the business invoicing system and obtain invoice related financial transaction data generated by the one or more payee businesses.

In accordance with one embodiment, obtaining access to invoice related financial transaction data generated by the one or more payee businesses includes, but is not limited to:
a. obtaining access to personal financial management and bill payment system user financial transaction data associated with the personal financial management and bill payment system, the personal financial management and bill payment system user financial transaction data representing financial transactions associated with users of the personal financial management and bill payment system;
b. analyzing the personal financial management and bill payment system user financial transaction data associated with a first payor user to identify payee data included in the financial transaction data associated with the first payor user, the payee data representing one or more payees associated with first payor user financial transactions associated with the first payor user represented by a portion of the personal financial management and bill payment system user financial transaction data associated with the first payor user;
c. obtaining access to business invoicing system business user identification data associated with a business invoicing system, the business user identification data representing business users of the business invoicing system;
d. accessing the payee data and the business user identification data and analyzing the payee data and business user identification data to determine if a payee represented in the payee data matches a business user of the business invoicing system represented in the business user identification data;
e. identifying a payee represented in the payee data that matches a business user of the business invoicing system represented in the business user identification data, the payee being a payee associated with first financial transaction data representing a first financial transaction included in the personal financial management and bill payment system user financial transaction data associated with the first payor user;
f. designating the payee represented in the payee data that matches the business user of the business invoicing system as a first payee business;
g. transforming status data associated with the first financial transaction data representing the first financial transaction to first invoice related financial transaction data;
h. processing the first invoice related financial transaction data as invoice related financial transaction data; and
i. providing the first payee business the capability to provide invoicing data representing invoices generated by the first payee business to the first payor user of the personal financial management and bill payment system through the personal financial management and bill payment system.

In accordance with one embodiment, obtaining access to invoice related financial transaction data generated by the one or more payee businesses includes, but is not limited to:
a. obtaining access to personal financial management and bill payment system user identification data associated with users of a personal financial management and bill payment system;
b. obtaining access to invoicing data generated through a business invoicing system, the invoicing data representing invoices sent from payee business users of the business invoicing system to payor customers of the payee business users of the business invoicing system;
c. monitoring the invoicing data and identifying first invoice data representing an invoice generated by a first payee business user of the business invoicing system associated with a first payor customer of the first payee business user of the business invoicing system;
d. analyzing the first invoice data to identify first payor customer identification data associated with the first payor customer of the first payee business user of the business invoicing system;
e. analyzing the personal financial management and bill payment system user identification data and the first payor customer identification data to determine if the first payor customer associated with the first payor customer identification data is a first payor user of the personal financial management and bill payment system;
f. if a determination is made that the first payor customer associated with the first payor customer identification data is a first payor user of the personal financial management and bill payment system, designating the first payor customer as a first payor user of the personal financial management and bill payment system; and
g. providing the first payee business user of the business invoicing system the capability to provide invoicing data representing invoices generated by the first payee business user of the business invoicing system to the first payor user of the personal financial management and bill payment system through the personal financial management and bill payment system.

In accordance with one embodiment, obtaining access to invoice related financial transaction data generated by the one or more payee businesses includes, but is not limited to:
a. obtaining access to personal financial management and bill payment system user identification data associated with users of a personal financial management and bill payment system;
b. obtaining access to business invoicing system payor customer identification data generated through a business invoicing system, the business invoicing system payor customer identification data being associated with payor customers of user payee businesses of a business invoicing system;
c. analyzing the personal financial management and bill payment system user identification data and the business invoicing system payor customer identification data to identify payor users of the personal financial management and bill payment system that are payor customers of business users of the business invoicing system;
d. identifying a payor user of the personal financial management and bill payment system that is a payor customer of a payee business user of the business invoicing system;
e. designating the payor user of the personal financial management and bill payment system a first payor user of the personal financial management and bill payment system;
f. providing the first payor user of the personal financial management and bill payment system the opportunity to integrate invoices generated by the first payee business user of the business invoicing system into the personal financial management and bill payment system; and
g. if the first payor user of the personal financial management and bill payment system agrees to integrate invoices generated by the first payee business user of the business invoicing system into the personal financial management and bill payment system, providing the first payee business user of the business invoicing system the capability to provide invoice data representing invoices generated by the first payee business user of the business invoicing system to the first payor user of the personal financial management and bill payment system through the personal financial management and bill payment system.

In accordance with one embodiment, obtaining access to invoice related financial transaction data generated by the one or more payee businesses includes any method, system, process and/or procedure for obtaining access to invoice related financial transaction data generated by the one or more payee businesses as discussed herein, known in the art at the time of filing, and/or as developed/made available after the time of filing.

In accordance with one embodiment, obtaining access to invoice related financial transaction data generated by the one or more payee businesses includes any method, system, process and/or procedure for obtaining access to invoice related financial transaction data generated by the one or more payee businesses as discussed in: U.S. patent application Ser. No. 15/140,117 (docket number INTU169676), filed on behalf of the same Inventors of the present patent application, filed on Apr. 27, 2016, entitled “METHOD AND SYSTEM FOR PROVIDING INVOICES GENERATED THROUGH A BUSINESS INVOICING SYSTEM TO A CUSTOMER USER OF A PERSONAL FINANCIAL MANAGEMENT AND BILL PAYMENT SYSTEM,” which is herein incorporated by reference in its entirety as if it were fully set forth herein; and/or U.S. patent application Ser. No. 15/140,131 (docket number INTU169677), filed on behalf of the same Inventors of the present patent application, filed on Apr. 27, 2016, entitled “METHOD AND SYSTEM FOR IDENTIFYING INVOICES THAT ARE PAID THROUGH A PERSONAL FINANCIAL MANAGEMENT AND BILL PAYMENT SYSTEM,” which is herein incorporated by reference in its entirety as if it were fully set forth herein; and/or U.S. patent application Ser. No. 15/142,708 (docket number INTU169678), filed on behalf of the same Inventors of the present patent application, filed on Apr. 29, 2016, entitled “METHOD AND SYSTEM FOR INTEGRATING BUSINESS INVOICES INTO A PERSONAL FINANCIAL MANAGEMENT AND BILL PAYMENT SYSTEM,” which is herein incorporated by reference in its entirety as if it were fully set forth herein.

In accordance with one embodiment, the invoice related financial transaction data is integrated into personal financial management and bill payment system payment due data associated with a personal financial management and bill payment system.

In one embodiment, the personal financial management and bill payment system payment due data represents one or more payments due associated with one or more users of the personal financial management and bill payment system as payment due items to be paid through the personal financial management and bill payment system.

In accordance with one embodiment, the invoice related financial transaction data is integrated into personal financial management and bill payment system payment due data associated with a personal financial management and bill payment system by assigning an initial personal financial management and bill payment system financial transaction category, such as an “uncategorized” financial transaction category, to the discrete invoices represented in the invoice related financial transaction data.

In accordance with one embodiment, the invoice related financial transaction data is integrated into personal financial management and bill payment system payment due data associated with a personal financial management and bill payment system by providing the discrete invoices represented in the invoice related financial transaction data as line items in a payment due or other financial transaction listing generated through the personal financial management and bill payment system.

In accordance with one embodiment, the invoice related financial transaction data is integrated into personal financial management and bill payment system payment due data associated with a personal financial management and bill payment system by any method, system, process and/or procedure for integrating invoice related financial transaction data into personal financial management and bill payment system payment due data as discussed herein, known in the art at the time of filing, and/or as developed/made available after the time of filing.

In accordance with various embodiments, the invoice related financial transaction data is integrated into personal financial management and bill payment system payment due data associated with a personal financial management and bill payment system by any method, system, process and/or procedure for integrating invoice related financial transaction data into personal financial management and bill payment system payment due data as discussed in: U.S. patent application Ser. No. 15/140,117 (docket number INTU169676), filed on behalf of the same Inventors of the present patent application, filed on Apr. 27, 2016, entitled “METHOD AND SYSTEM FOR PROVIDING INVOICES GENERATED THROUGH A BUSINESS INVOICING SYSTEM TO A CUSTOMER USER OF A PERSONAL FINANCIAL MANAGEMENT AND BILL PAYMENT SYSTEM,” which is herein incorporated by reference in its entirety as if it were fully set forth herein; and/or U.S. patent application Ser. No. 15/140,131 (docket number INTU169677), filed on behalf of the same Inventors of the present patent application, filed on Apr. 27, 2016, entitled “METHOD AND SYSTEM FOR IDENTIFYING INVOICES THAT ARE PAID THROUGH A PERSONAL FINANCIAL MANAGEMENT AND BILL PAYMENT SYSTEM,” which is herein incorporated by reference in its entirety as if it were fully set forth herein; and/or U.S. patent application Ser. No. 15/142,708 (docket number INTU169678), filed on behalf of the same Inventors of the present patent application, filed on Apr. 29, 2016, entitled “METHOD AND SYSTEM FOR INTEGRATING BUSINESS INVOICES INTO A PERSONAL FINANCIAL MANAGEMENT AND BILL PAYMENT SYSTEM,” which is herein incorporated by reference in its entirety as if it were fully set forth herein.

In accordance with one embodiment, access to the personal financial management and bill payment system and the personal financial management and bill payment system payment due data, including the integrated invoice related financial transaction data, and the additional invoice related financial transaction data is obtained.

In accordance with one embodiment, one or more processors associated with one or more computing systems are utilized to obtain access to the personal financial management and bill payment system and the personal financial management and bill payment system payment due data, including the integrated invoice related financial transaction data, and the additional invoice related financial transaction data.

In accordance with one embodiment, the personal financial management and bill payment system and the personal financial management and bill payment system payment due data, including the integrated invoice related financial transaction data, and the additional invoice related financial transaction data is analyzed to identify a first discrete invoice represented in the invoice related financial transaction data that includes additional first invoice related financial transaction data associated with the first discrete invoice represented in the invoice related financial transaction data.

In accordance with one embodiment, the personal financial management and bill payment system and the personal financial management and bill payment system payment due data, including the integrated invoice related financial transaction data, and the additional invoice related financial transaction data is analyzed using one or more processors associated with one or more computing systems.

In accordance with one embodiment, the additional first invoice related financial transaction data is identified and/or extracted.

In accordance with one embodiment, the additional first invoice related financial transaction data includes Level-3 data associated with at least one discrete invoice represented in the invoice related financial transaction data and provides additional transaction details, and/or information, associated with the at least one discrete invoice represented in the invoice related financial transaction data.

As noted above, Level-3 financial transaction data includes data indicating not only the payee, payor, amount, and date of the financial transaction, but also line item listing data representing the item actually purchased, and the amount paid for each item listed. Specific examples/fields of Level-3 data include, but are not limited to: Quantity data; Item ID or SKU; Item description; Unit price; Extended price; Unit of measure (each); Commodity code; Line discount; Ship-From Zip Code; Destination Zip Code; Invoice Number; Item Extended Amount; Freight Amount; Duty Amount, etc. Consequently, Level-3 data is the most desired and informative/useful type of financial transaction data, particularly for identifying tax related financial transactions.

However, as also noted above, absent invoice related financial transaction data, Level-3 data is often difficult to obtain and often requires special equipment and permissions. For instance, historically, when Level-3 data is obtained from traditional sources, such as credit card financial transactions, bill payments, and point-of-sale systems, there have been significant obstacles for businesses wanting to provide and/or obtain Level-3 data. The most obvious is that card terminals do not typically prompt for the additional financial transaction related data, and if they did, data would be manually entered from a numeric keypad. Consequently, businesses who want to obtain, supply, and process Level-3 data need to input their transaction information from specialized point-of-sale software systems that prompt them for the required information.

As a result, absent the disclosed embodiment, most businesses will never have the opportunity to obtain and/or accept Level-3 data in any traditional way. Therefore, invoice related financial transaction data represents a valuable opportunity to obtain Level-3 data in a potentially simple, efficient, and cost effective way, without requiring special processes, systems, equipment, and permissions. However, using the disclosed embodiments, Level-3 data associated with at least one discrete invoice represented in the invoice related financial transaction data is identified, extracted, and/or otherwise obtained.

In accordance with one embodiment, the additional first invoice related financial transaction data includes additional input data to one or more payor users associated with at least one discrete invoice represented in the invoice related financial transaction data of the personal financial management and bill payment system from one or more business payees associated with at least one discrete invoice represented in the invoice related financial transaction data. In accordance with one embodiment, the additional first invoice related financial transaction data includes additional input data from one or more payor users associated with at least one discrete invoice represented in the invoice related financial transaction data of the personal financial management and bill payment system to one or more business payees associated with at least one discrete invoice represented in the invoice related financial transaction data.

In various embodiments, this additional input data representing notes and/or input added to the invoices represented in the invoice related financial transaction data includes various additional invoice related financial transaction data that can be identified, extracted, and utilized as described below.

In accordance with one embodiment, the additional first invoice related financial transaction data is identified, extracted, and analyzed to determine if the first discrete invoice represented in the invoice related financial transaction data is a tax related invoice having potential tax ramifications.

As noted above, herein, the term “tax related invoice” includes any invoice associated with a financial transaction, i.e., requesting and/or resulting in, a transfer or re-categorization of funds, that includes a transfer or re-categorization of funds that has potential tax ramifications to a user, i.e., has a potential for resulting in tax consequences for the user and/or to potentially cause a change in the user's tax liability.

Examples of tax related invoices include, but are not limited to; invoices for home repair and/or home improvement work; invoices for child care; invoices associated with charitable donations and projects; invoices associated with healthcare; invoices associated with business automobile travel; invoices associated with business expenses; invoices associated with business travel; invoices associated with business related computing systems, office equipment, and/or office/business electronics; invoices for professional services related to a business; invoices associated with office supplies; and/or any other invoices requesting and/or resulting in, a transfer or re-categorization of funds, that includes a transfer or re-categorization of funds that has potential tax ramifications to a user, i.e., has a potential for resulting in tax consequences for the user and/or to potentially cause a change in the user's tax liability.

In accordance with one embodiment, based, at least in part, on the analysis of the additional invoice related financial transaction data, a determination is made that the first discrete invoice represented in the invoice related financial transaction data is a tax related invoice having potential tax ramifications.

In accordance with one embodiment, once a determination is made that the first discrete invoice represented in the invoice related financial transaction data is a tax related invoice having potential tax ramifications, first invoice status data associated with the first discrete invoice represented in the invoice related financial transaction data is transformed into tax related invoice status data.

In accordance with one embodiment, the portion of the invoice related financial transaction data representing the first discrete invoice is then processed as tax related invoice financial transaction data.

In accordance with one embodiment, the portion of the invoice related financial transaction data representing the first discrete invoice is processed as tax related invoice financial transaction data using the personal financial management and bill payment system.

In accordance with one embodiment, the portion of the invoice related financial transaction data representing the first discrete invoice is processed as tax related invoice financial transaction by assigning a tax category to the portion of the invoice related financial transaction data representing the first discrete invoice. In one embodiment, the assigned tax category is defined by one or more local, state, or federal tax agencies.

In accordance with one embodiment, the portion of the invoice related financial transaction data representing the first discrete invoice is processed as tax related invoice financial transaction data by providing a copy of the portion of the invoice related financial transaction data representing the first discrete invoice to a tax preparation and filing system for processing as tax related invoice financial transaction data.

As noted above, the terms “tax preparation system,” “tax filing system,” “tax return preparation and filing system,” and “tax preparation and filing system,” are used interchangeably and include, but are not limited to, the following: computing system, desktop system, mobile system, and/or wearable device implemented, and/or online, and/or web-based, storage based, persistence based, tax preparation and filing and/or processing systems, services, packages, programs, modules, or applications; and various other tax preparation and filing systems, services, packages, programs, modules, or applications, used to process and/or facilitate the filing of electronic tax and/or hardcopy tax return documents, whether known at the time of filling, or as developed later.

Specific examples of personal financial management and bill payment systems include, but are not limited to TurboTax™ available from Intuit, Inc. of Mountain View, Calif.; TurboTax Online™ available from Intuit, Inc. of Mountain View, Calif.; and/or various other software systems discussed herein, and/or known to those of skill in the art at the time of filing, and/or as developed after the time of filing.

Currently, personal financial management and bill payment systems, business invoicing systems, and tax preparation systems are typically distinct software systems operated and/or used by at least two distinct parties, e.g., a customer of a business and an owner of a business, respectively. Currently, personal financial management and bill payment systems, business invoicing systems, and tax preparation systems typically operate in isolation from each other, even when they are offered by the same personal financial management and bill payment systems, business invoicing systems, and tax preparation systems provider.

As a specific illustrative example, in one embodiment, the personal financial management and bill payment system used by a customer of a business, or other user, could be a personal financial transaction management system such as Mint™, available from Intuit, Inc. of Mountain View, Calif. In this specific illustrative example, a business invoicing system, used by a business user, could be a business invoicing system such as QuickBooks™, available from Intuit, Inc. of Mountain View, Calif. In this specific illustrative example, a tax preparation system, used by a business user, a customer of a business, or other user, could be a tax preparation system such as TurboTax™, available from Intuit, Inc. of Mountain View, Calif. As seen in this specific illustrative example, the personal financial management and bill payment system, the business invoicing system, and the tax preparation system are offered by the same software system provider, i.e., in this specific case, Intuit, Inc. of Mountain View, Calif.

Consequently, according to one embodiment, personal financial management and bill payment systems, business invoicing systems, and tax preparation systems are provided the opportunity to share, “cross-pollinate,” and cross-confirm supported data. This approach has several unique advantages and significantly enhances the user experience associated with all three systems.

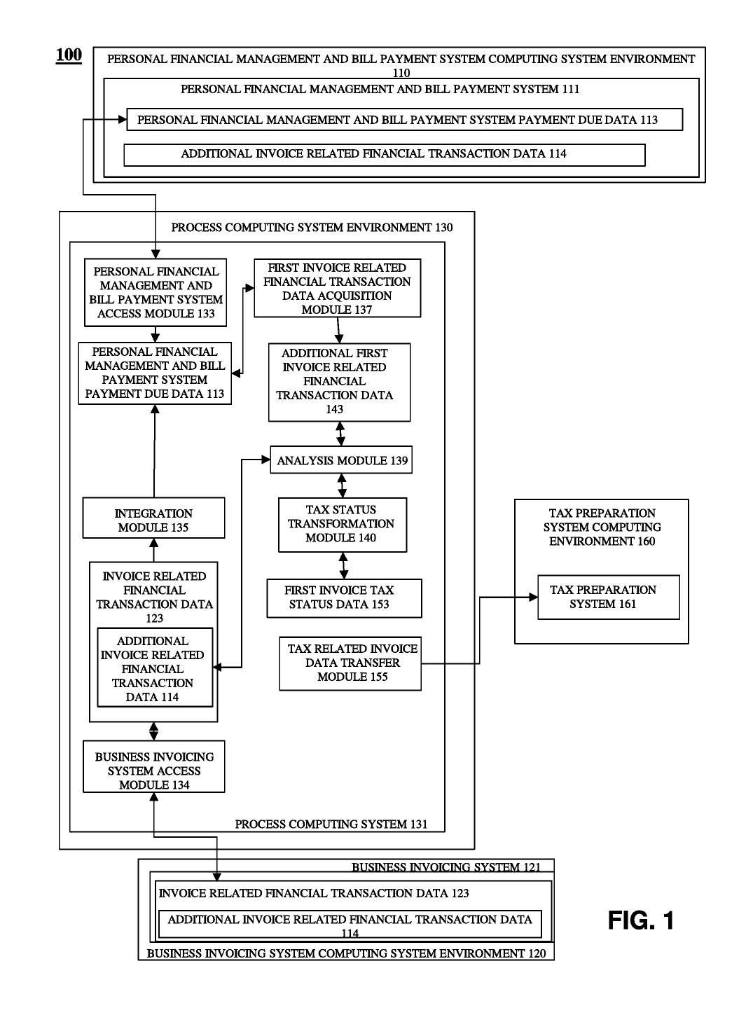

FIG. 1 is a high level functionality-based block diagram of a hardware and production environment 100 for integrating invoice related financial transaction data into a personal financial management and bill payment system to more accurately identify and categorize tax related financial transactions, in accordance with one embodiment.

As seen in FIG. 1, in this specific illustrative example, production environment 100 includes: personal financial management and bill payment system computing system environment 110, including personal financial management and bill payment system 111; business invoicing system computing system environment 120, including business invoicing system 121; process computing system environment 130, including process computing system 131; and tax preparation system computing environment 160, including tax preparation system 161

As seen in FIG. 1, in the specific illustrative example of FIG. 1, personal financial management and bill payment system 111 includes personal financial management and bill payment system payment due data 113 associated with one or more users (not shown) of personal financial management and bill payment system 111.

In one embodiment, personal financial management and bill payment system payment due data 113 represents one or more bills associated with one or more users (not shown) of personal financial management and bill payment system 111 to be paid through personal financial management and bill payment system 111. In one embodiment, personal financial management and bill payment system payment due data 113 includes data representing a payment due item listing (not shown).

As seen in FIG. 1, in the specific illustrative example of FIG. 1, business invoicing system 121 includes invoice related financial transaction data 123 generated by the one or more payee businesses (not shown).

In one embodiment, invoice related financial transaction data 123 represents two or more discrete invoices (not shown) submitted by one or more payee businesses (not shown) requesting payment by one or more payor users (not shown) of personal financial management and bill payment system 111.

In one embodiment, invoice related financial transaction data 123 includes payee business identity data associated with each discrete invoice represented in the invoice related financial transaction data (not shown). In one embodiment, the payee business identity data represents the identity of the payee business associated with each discrete invoice represented in the invoice related financial transaction data.

In one embodiment, invoice related financial transaction data 123 also includes payor user identity data associated with each discrete invoice represented in the invoice related financial transaction data (not shown). In one embodiment, the payor user identity data represents the identity of the payor user associated with each discrete invoice represented in the invoice related financial transaction data.

In one embodiment, invoice related financial transaction data 123 further includes invoice amount data associated with each discrete invoice represented in the invoice related financial transaction data (not shown). In one embodiment, the invoice amount data represents the payment amount associated with each discrete invoice represented in the invoice related financial transaction data.

In one embodiment, invoice related financial transaction data 123 includes additional invoice related financial transaction data 114 providing additional transaction details, and/or information, associated with the at least one discrete invoice represented in the invoice related financial transaction data 123.

As seen in FIG. 1, in the specific illustrative example of FIG. 1, process computing system 131 includes business invoicing system access module 134, i.e., one example of an invoice related financial transaction data acquisition module, for obtaining access to invoice related financial transaction data 123 and additional invoice related financial transaction data 114.

As seen in FIG. 1, in the specific illustrative example of FIG. 1, process computing system 131 includes personal financial management and bill payment system access module 133 for obtaining access to personal financial management and bill payment system 111, personal financial management and bill payment system payment due data 113, and additional invoice related financial transaction data 114, as integrated into personal financial management and bill payment system payment due data 113 by integration module 135.

As seen in FIG. 1, in the specific illustrative example of FIG. 1, process computing system 131 includes integration module 135 for integrating invoice related financial transaction data 123, including additional invoice related financial transaction data 114, into personal financial management and bill payment system payment due data 113 associated with personal financial management and bill payment system 111.

As seen in FIG. 1, in the specific illustrative example of FIG. 1, process computing system 131 includes first invoice related financial transaction data acquisition module 137 for analyzing invoice related financial transaction data 123 of personal financial management and bill payment system payment due data 113 and identifying and extracting additional first invoice related financial transaction data 143 associated with a first discrete invoice (not shown) represented in invoice related financial transaction data 123.

As seen in FIG. 1, in the specific illustrative example of FIG. 1, process computing system 131 includes analysis module 139 for analyzing additional first invoice related financial transaction data 114 to determine if the first discrete invoice (not shown) represented in invoice related financial transaction data 123 is a tax related invoice having potential tax ramifications.

As seen in FIG. 1, in the specific illustrative example of FIG. 1, process computing system 131 includes tax status transformation module 140 for transforming first invoice status data 153 associated with the first discrete invoice (not shown) represented in invoice related financial transaction data 123 to first invoice tax status data 153 indicating a tax related invoice status if analysis module 139 determines that the first discrete invoice (not shown) represented in invoice related financial transaction data 123 is a tax related invoice having potential tax ramifications.

As seen in FIG. 1, in the specific illustrative example of FIG. 1, process computing system 131 includes tax related invoice data transfer module 155 for transferring the first discrete invoice (not shown) represented in invoice related financial transaction data 123 having a first invoice status data 153 indicating a tax related invoice status to tax preparation system computing environment 160 and tax preparation system 161 for processing as tax related invoice financial transaction data

The disclosed embodiments provide an efficient, effective, and highly adaptable solution to the long standing technical need in the bill payment, invoice processing, tax preparation and filing, and financial management, arts for automatically integrating invoice related financial transaction data into a personal financial management and bill payment system, and/or obtaining, identifying, or distinguishing, invoice related financial transaction data, processing the integrated invoice related financial transaction data to extract additional invoice related financial transaction data, such as Level-3 financial transaction data, included in the invoice related financial transaction data, and then using the additional invoice related financial transaction data to more accurately and automatically identify tax related financial transactions for processing as tax related financial transactions having tax ramifications.

However, the disclosed method and system for integrating invoice related financial transaction data into a personal financial management and bill payment system to more accurately identify and categorize tax related financial transactions does not encompass, embody, or preclude other forms of innovation in the area of automated financial transaction bill payment, processing, and reporting, and/or tax preparation and filing. In addition, the disclosed method and system for integrating invoice related financial transaction data into a personal financial management and bill payment system to more accurately identify and categorize tax related financial transactions is not related to any fundamental economic practice, fundamental data processing practice, mental steps, or pen and paper based solution. In fact, the disclosed embodiments are directed to providing solutions to the relatively new problems associated with the automatic processing and display of electronic financial transaction data obtained from multiple sources, making electronic bill payments and determining tax liabilities, and the management and processing of large amounts of data, i.e., “big data.” Consequently, the disclosed method and system for integrating invoice related financial transaction data into a personal financial management and bill payment system to more accurately identify and categorize tax related financial transactions is not directed to, does not encompass, and is not merely, an abstract idea or concept.

In addition, the disclosed method and system for integrating invoice related financial transaction data into a personal financial management and bill payment system to more accurately identify and categorize tax related financial transactions provides for significant improvements to the technical fields of electronic transaction data processing, tax return preparation, invoice processing, financial transaction categorization, information dissemination, data processing, data management, data filtering and mining, automatic electronic bill payment, and user experience.

In addition, by allowing for the integration of invoices and invoice data into a personal financial management and bill payment system, the disclosed method and system for integrating invoice related financial transaction data into a personal financial management and bill payment system to more accurately identify and categorize tax related financial transactions helps users of the personal financial management and bill payment system identify and pay their invoices and taxes. This, in turn, helps avoid the reissuance and repeated transmission of payment and tax due reminders and for the entry, processing, and dissemination, of redundant invoice and tax data; thereby eliminating unnecessary data analysis before resources are allocated to processing, and/or correcting, redundant data and the redundant data is further transmitted/distributed.

In addition, the disclosed method and system for integrating invoice related financial transaction data into a personal financial management and bill payment system to more accurately identify and categorize tax related financial transactions provides for the entry, processing, and dissemination, of only relevant portions of tax related data; thereby eliminating unnecessary data analysis and correction before resources are allocated to processing, and/or correcting, faulty/irrelevant data, and/or the faulty/irrelevant data is further transmitted/distributed.

Consequently, using the disclosed method and system for integrating invoice related financial transaction data into a personal financial management and bill payment system to more accurately identify and categorize tax related financial transactions results in more efficient use of human and non-human resources, fewer processor cycles being utilized, reduced memory utilization, and less communications bandwidth being utilized to relay data to, and from, backend systems and client systems.

As a result, computing systems are transformed into faster, more efficient, and more effective computing systems by implementing the method and system for integrating invoice related financial transaction data into a personal financial management and bill payment system to more accurately identify and categorize tax related financial transactions.

### Process

In accordance with one embodiment, invoice related financial transaction data is obtained and integrated into a personal financial management and bill payment system. The integrated invoice related financial transaction data is then analyzed to identify and extract additional invoice related financial transaction data, such as Level-3 financial transaction data, included in the invoice related financial transaction data. The additional invoice related financial transaction data is then used to more accurately and automatically identify tax related financial transactions for processing as tax related financial transactions having tax ramifications.

Consequently, using the disclosed embodiments, additional invoice related financial transaction data, such as Level-3 financial transaction data, included in invoice related financial transaction data is leveraged to identify tax related financial transactions for processing as tax related financial transactions having tax ramifications.

Therefore, disclosed herein is a technical solution to the long standing technical need in the financial management and user experience arts for automatically integrating invoice related financial transaction data into a personal financial management and bill payment system, and/or obtaining, identifying, or distinguishing, invoice related financial transaction data, processing the integrated invoice related financial transaction data to extract additional invoice related financial transaction data, such as Level-3 financial transaction data, included in the invoice related financial transaction data, and then using the additional invoice related financial transaction data to more accurately and automatically identify tax related financial transactions for processing as tax related financial transactions having tax ramifications.

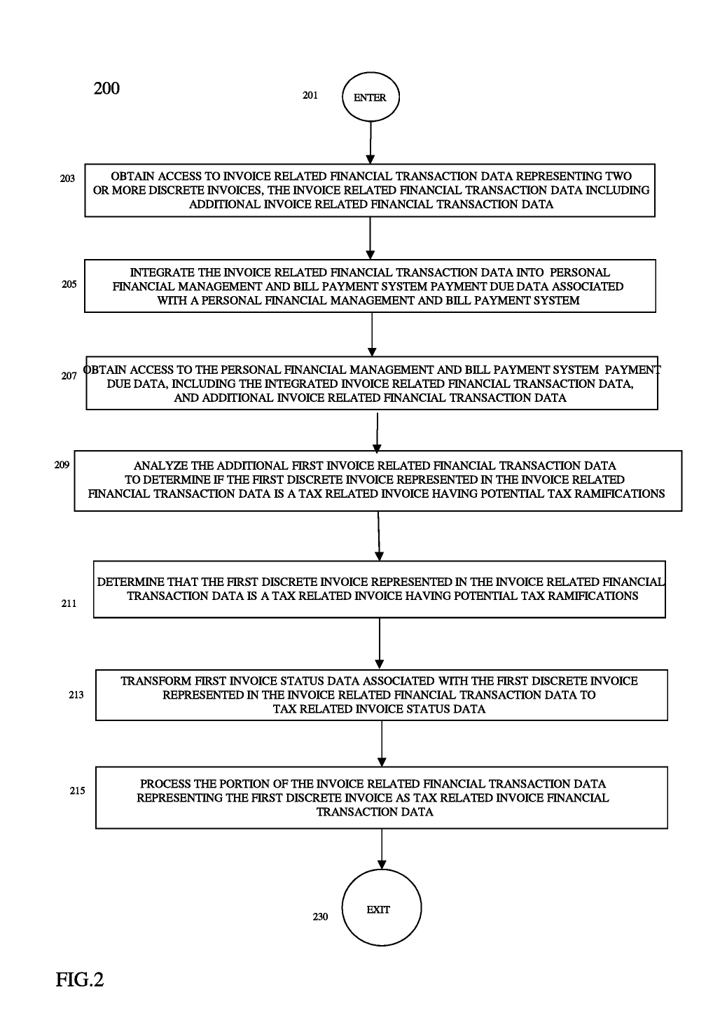

FIG. 2 is a flow chart representing one example of a process 200 for integrating invoice related financial transaction data into a personal financial management and bill payment system to more accurately identify and categorize tax related financial transactions in accordance with one embodiment.

As seen in FIG. 2, process 200 for integrating invoice related financial transaction data into a personal financial management and bill payment system to more accurately identify and categorize tax related financial transactions begins at ENTER OPERATION 201 and process flow proceeds to OBTAIN ACCESS TO INVOICE RELATED FINANCIAL TRANSACTION DATA REPRESENTING TWO OR MORE DISCRETE INVOICES, THE INVOICE RELATED FINANCIAL TRANSACTION DATA INCLUDING ADDITIONAL INVOICE RELATED FINANCIAL TRANSACTION DATA OPERATION 203.

In one embodiment, at OBTAIN ACCESS TO INVOICE RELATED FINANCIAL TRANSACTION DATA REPRESENTING TWO OR MORE DISCRETE INVOICES, THE INVOICE RELATED FINANCIAL TRANSACTION DATA INCLUDING ADDITIONAL INVOICE RELATED FINANCIAL TRANSACTION DATA OPERATION 203, access to invoice related financial transaction data generated by the one or more payee businesses is obtained.

In one embodiment, the obtained invoice related financial transaction data of OBTAIN ACCESS TO INVOICE RELATED FINANCIAL TRANSACTION DATA REPRESENTING TWO OR MORE DISCRETE INVOICES, THE INVOICE RELATED FINANCIAL TRANSACTION DATA INCLUDING ADDITIONAL INVOICE RELATED FINANCIAL TRANSACTION DATA OPERATION 203 represents two or more discrete invoices submitted by one or more payee businesses requesting payment by one or more payor users of the personal financial management and bill payment system.

In one embodiment, the invoice related financial transaction data of OBTAIN ACCESS TO INVOICE RELATED FINANCIAL TRANSACTION DATA REPRESENTING TWO OR MORE DISCRETE INVOICES, THE INVOICE RELATED FINANCIAL TRANSACTION DATA INCLUDING ADDITIONAL INVOICE RELATED FINANCIAL TRANSACTION DATA OPERATION 203 includes payee business identity data associated with each discrete invoice represented in the invoice related financial transaction data. In one embodiment, the payee business identity data represents the identity of the payee business associated with each discrete invoice represented in the invoice related financial transaction data.

In one embodiment, the invoice related financial transaction data of OBTAIN ACCESS TO INVOICE RELATED FINANCIAL TRANSACTION DATA REPRESENTING TWO OR MORE DISCRETE INVOICES, THE INVOICE RELATED FINANCIAL TRANSACTION DATA INCLUDING ADDITIONAL INVOICE RELATED FINANCIAL TRANSACTION DATA OPERATION 203 also includes payor user identity data associated with each discrete invoice represented in the invoice related financial transaction data. In one embodiment, the payor user identity data represents the identity of the payor user associated with each discrete invoice represented in the invoice related financial transaction data.

In one embodiment, the invoice related financial transaction data of OBTAIN ACCESS TO INVOICE RELATED FINANCIAL TRANSACTION DATA REPRESENTING TWO OR MORE DISCRETE INVOICES, THE INVOICE RELATED FINANCIAL TRANSACTION DATA INCLUDING ADDITIONAL INVOICE RELATED FINANCIAL TRANSACTION DATA OPERATION 203 further includes invoice amount data associated with each discrete invoice represented in the invoice related financial transaction data. In one embodiment, the invoice amount data represents the payment amount associated with each discrete invoice represented in the invoice related financial transaction data.

In one embodiment, the invoice related financial transaction data of OBTAIN ACCESS TO INVOICE RELATED FINANCIAL TRANSACTION DATA REPRESENTING TWO OR MORE DISCRETE INVOICES, THE INVOICE RELATED FINANCIAL TRANSACTION DATA INCLUDING ADDITIONAL INVOICE RELATED FINANCIAL TRANSACTION DATA OPERATION 203 includes additional invoice related financial transaction data, such as but not limited to, Level-3 financial transaction data.

In one embodiment, the additional invoice related financial transaction data of OBTAIN ACCESS TO INVOICE RELATED FINANCIAL TRANSACTION DATA REPRESENTING TWO OR MORE DISCRETE INVOICES, THE INVOICE RELATED FINANCIAL TRANSACTION DATA INCLUDING ADDITIONAL INVOICE RELATED FINANCIAL TRANSACTION DATA OPERATION 203 is associated with at least one discrete invoice represented in the invoice related financial transaction data and provides additional transaction details, and/or information, associated with at least one discrete invoice represented in the invoice related financial transaction data.

In accordance with one embodiment, at OBTAIN ACCESS TO INVOICE RELATED FINANCIAL TRANSACTION DATA REPRESENTING TWO OR MORE DISCRETE INVOICES, THE INVOICE RELATED FINANCIAL TRANSACTION DATA INCLUDING ADDITIONAL INVOICE RELATED FINANCIAL TRANSACTION DATA OPERATION 203 the invoice related financial transaction data generated by the one or more payee businesses is obtained from a business invoicing system provided to business users of the business invoicing system.

In accordance with one embodiment, at OBTAIN ACCESS TO INVOICE RELATED FINANCIAL TRANSACTION DATA REPRESENTING TWO OR MORE DISCRETE INVOICES, THE INVOICE RELATED FINANCIAL TRANSACTION DATA INCLUDING ADDITIONAL INVOICE RELATED FINANCIAL TRANSACTION DATA OPERATION 203 one or more processors associated with one or more computing systems are utilized to obtain access to the business invoicing system and obtain invoice related financial transaction data generated by the one or more payee businesses.

In accordance with one embodiment, obtaining access to invoice related financial transaction data generated by the one or more payee businesses at OBTAIN ACCESS TO INVOICE RELATED FINANCIAL TRANSACTION DATA REPRESENTING TWO OR MORE DISCRETE INVOICES, THE INVOICE RELATED FINANCIAL TRANSACTION DATA INCLUDING ADDITIONAL INVOICE RELATED FINANCIAL TRANSACTION DATA OPERATION 203 includes, but is not limited to:
a. obtaining access to personal financial management and bill payment system user financial transaction data associated with the personal financial management and bill payment system, the personal financial management and bill payment system user financial transaction data representing financial transactions associated with users of the personal financial management and bill payment system;
b. analyzing the personal financial management and bill payment system user financial transaction data associated with a first payor user to identify payee data included in the financial transaction data associated with the first payor user, the payee data representing one or more payees associated with first payor user financial transactions associated with the first payor user represented by a portion of the personal financial management and bill payment system user financial transaction data associated with the first payor user;
c. obtaining access to business invoicing system business user identification data associated with a business invoicing system, the business user identification data representing business users of the business invoicing system;
d. accessing the payee data and the business user identification data and analyzing the payee data and business user identification data to determine if a payee represented in the payee data matches a business user of the business invoicing system represented in the business user identification data;
e. identifying a payee represented in the payee data that matches a business user of the business invoicing system represented in the business user identification data, the payee being a payee associated with first financial transaction data representing a first financial transaction included in the personal financial management and bill payment system user financial transaction data associated with the first payor user;
f. designating the payee represented in the payee data that matches the business user of the business invoicing system as a first payee business;
g. transforming status data associated with the first financial transaction data representing the first financial transaction to first invoice related financial transaction data;
h. processing the first invoice related financial transaction data as invoice related financial transaction data; and
i. providing the first payee business the capability to provide invoicing data representing invoices generated by the first payee business to the first payor user of the personal financial management and bill payment system through the personal financial management and bill payment system.

In accordance with one embodiment, obtaining access to invoice related financial transaction data generated by the one or more payee businesses at OBTAIN ACCESS TO INVOICE RELATED FINANCIAL TRANSACTION DATA REPRESENTING TWO OR MORE DISCRETE INVOICES, THE INVOICE RELATED FINANCIAL TRANSACTION DATA INCLUDING ADDITIONAL INVOICE RELATED FINANCIAL TRANSACTION DATA OPERATION 203 includes, but is not limited to:
a. obtaining access to personal financial management and bill payment system user identification data associated with users of a personal financial management and bill payment system;
b. obtaining access to invoicing data generated through a business invoicing system, the invoicing data representing invoices sent from payee business users of the business invoicing system to payor customers of the payee business users of the business invoicing system;
c. monitoring the invoicing data and identifying first invoice data representing an invoice generated by a first payee business user of the business invoicing system associated with a first payor customer of the first payee business user of the business invoicing system;
d. analyzing the first invoice data to identify first payor customer identification data associated with the first payor customer of the first payee business user of the business invoicing system;
e. analyzing the personal financial management and bill payment system user identification data and the first payor customer identification data to determine if the first payor customer associated with the first payor customer identification data is a first payor user of the personal financial management and bill payment system;
f. if a determination is made that the first payor customer associated with the first payor customer identification data is a first payor user of the personal financial management and bill payment system, designating the first payor customer as a first payor user of the personal financial management and bill payment system; and
g. providing the first payee business user of the business invoicing system the capability to provide invoicing data representing invoices generated by the first payee business user of the business invoicing system to the first payor user of the personal financial management and bill payment system through the personal financial management and bill payment system.

In accordance with one embodiment, obtaining access to invoice related financial transaction data generated by the one or more payee businesses at OBTAIN ACCESS TO INVOICE RELATED FINANCIAL TRANSACTION DATA REPRESENTING TWO OR MORE DISCRETE INVOICES, THE INVOICE RELATED FINANCIAL TRANSACTION DATA INCLUDING ADDITIONAL INVOICE RELATED FINANCIAL TRANSACTION DATA OPERATION 203 includes, but is not limited to:
a. obtaining access to personal financial management and bill payment system user identification data associated with users of a personal financial management and bill payment system;
b. obtaining access to business invoicing system payor customer identification data generated through a business invoicing system, the business invoicing system payor customer identification data being associated with payor customers of user payee businesses of a business invoicing system;
c. analyzing the personal financial management and bill payment system user identification data and the business invoicing system payor customer identification data to identify payor users of the personal financial management and bill payment system that are payor customers of business users of the business invoicing system;
d. identifying a payor user of the personal financial management and bill payment system that is a payor customer of a payee business user of the business invoicing system;
e. designating the payor user of the personal financial management and bill payment system a first payor user of the personal financial management and bill payment system;
f. providing the first payor user of the personal financial management and bill payment system the opportunity to integrate invoices generated by the first payee business user of the business invoicing system into the personal financial management and bill payment system; and
g. if the first payor user of the personal financial management and bill payment system agrees to integrate invoices generated by the first payee business user of the business invoicing system into the personal financial management and bill payment system, providing the first payee business user of the business invoicing system the capability to provide invoice data representing invoices generated by the first payee business user of the business invoicing system to the first payor user of the personal financial management and bill payment system through the personal financial management and bill payment system.

In accordance with one embodiment, obtaining access to invoice related financial transaction data generated by the one or more payee businesses at OBTAIN ACCESS TO INVOICE RELATED FINANCIAL TRANSACTION DATA REPRESENTING TWO OR MORE DISCRETE INVOICES, THE INVOICE RELATED FINANCIAL TRANSACTION DATA INCLUDING ADDITIONAL INVOICE RELATED FINANCIAL TRANSACTION DATA OPERATION 203 includes any method, system, process and/or procedure for obtaining access to invoice related financial transaction data generated by the one or more payee businesses as discussed herein, known in the art at the time of filing, and/or as developed/made available after the time of filing.

In accordance with one embodiment, obtaining access to invoice related financial transaction data generated by the one or more payee businesses at OBTAIN ACCESS TO INVOICE RELATED FINANCIAL TRANSACTION DATA REPRESENTING TWO OR MORE DISCRETE INVOICES, THE INVOICE RELATED FINANCIAL TRANSACTION DATA INCLUDING ADDITIONAL INVOICE RELATED FINANCIAL TRANSACTION DATA OPERATION 203 includes any method, system, process and/or procedure for obtaining access to invoice related financial transaction data generated by the one or more payee businesses as discussed in: U.S. patent application Ser. No. 15/140,117 (docket number INTU169676), filed on behalf of the same Inventors of the present patent application, filed on Apr. 27, 2016, entitled “METHOD AND SYSTEM FOR PROVIDING INVOICES GENERATED THROUGH A BUSINESS INVOICING SYSTEM TO A CUSTOMER USER OF A PERSONAL FINANCIAL MANAGEMENT AND BILL PAYMENT SYSTEM,” which is herein incorporated by reference in its entirety as if it were fully set forth herein; and/or U.S. patent application Ser. No. 15/140,131 (docket number INTU169677), filed on behalf of the same Inventors of the present patent application, filed on Apr. 27, 2016, entitled “METHOD AND SYSTEM FOR IDENTIFYING INVOICES THAT ARE PAID THROUGH A PERSONAL FINANCIAL MANAGEMENT AND BILL PAYMENT SYSTEM,” which is herein incorporated by reference in its entirety as if it were fully set forth herein; and/or U.S. patent application Ser. No. 15/142,708 (docket number INTU169678), filed on behalf of the same Inventors of the present patent application, filed on Apr. 29, 2016, entitled “METHOD AND SYSTEM FOR INTEGRATING BUSINESS INVOICES INTO A PERSONAL FINANCIAL MANAGEMENT AND BILL PAYMENT SYSTEM,” which is herein incorporated by reference in its entirety as if it were fully set forth herein.

In one embodiment once access to invoice related financial transaction data generated by the one or more payee businesses is obtained at OBTAIN ACCESS TO INVOICE RELATED FINANCIAL TRANSACTION DATA REPRESENTING TWO OR MORE DISCRETE INVOICES, THE INVOICE RELATED FINANCIAL TRANSACTION DATA INCLUDING ADDITIONAL INVOICE RELATED FINANCIAL TRANSACTION DATA OPERATION 203, process flow proceeds to INTEGRATE THE INVOICE RELATED FINANCIAL TRANSACTION DATA INTO PERSONAL FINANCIAL MANAGEMENT AND BILL PAYMENT SYSTEM PAYMENT DUE DATA ASSOCIATED WITH A PERSONAL FINANCIAL MANAGEMENT AND BILL PAYMENT SYSTEM OPERATION 205.

In one embodiment, at INTEGRATE THE INVOICE RELATED FINANCIAL TRANSACTION DATA INTO PERSONAL FINANCIAL MANAGEMENT AND BILL PAYMENT SYSTEM PAYMENT DUE DATA ASSOCIATED WITH A PERSONAL FINANCIAL MANAGEMENT AND BILL PAYMENT SYSTEM OPERATION 205, the invoice related financial transaction data of OBTAIN ACCESS TO INVOICE RELATED FINANCIAL TRANSACTION DATA REPRESENTING TWO OR MORE DISCRETE INVOICES, THE INVOICE RELATED FINANCIAL TRANSACTION DATA INCLUDING ADDITIONAL INVOICE RELATED FINANCIAL TRANSACTION DATA OPERATION 203 is integrated into personal financial management and bill payment system payment due data associated with a personal financial management and bill payment system.

In one embodiment, a personal financial management and bill payment system is provided using one or more computing systems.

In accordance with one embodiment, at INTEGRATE THE INVOICE RELATED FINANCIAL TRANSACTION DATA INTO PERSONAL FINANCIAL MANAGEMENT AND BILL PAYMENT SYSTEM PAYMENT DUE DATA ASSOCIATED WITH A PERSONAL FINANCIAL MANAGEMENT AND BILL PAYMENT SYSTEM OPERATION 205 the invoice related financial transaction data is integrated into personal financial management and bill payment system payment due data associated with the personal financial management and bill payment system using one or more processors associated with one or more computing systems.

In one embodiment, the personal financial management and bill payment system payment due data represents one or more payments due associated with one or more users of the personal financial management and bill payment system as payment due items to be paid through the personal financial management and bill payment system.

In accordance with one embodiment, the invoice related financial transaction data is integrated into personal financial management and bill payment system payment due data associated with a personal financial management and bill payment system at INTEGRATE THE INVOICE RELATED FINANCIAL TRANSACTION DATA INTO PERSONAL FINANCIAL MANAGEMENT AND BILL PAYMENT SYSTEM PAYMENT DUE DATA ASSOCIATED WITH A PERSONAL FINANCIAL MANAGEMENT AND BILL PAYMENT SYSTEM OPERATION 205 by providing the discrete invoices represented in the invoice related financial transaction data as line items in a payment due or other financial transaction listing generated through the personal financial management and bill payment system.

In accordance with one embodiment, the invoice related financial transaction data is integrated into personal financial management and bill payment system payment due data associated with a personal financial management and bill payment system at INTEGRATE THE INVOICE RELATED FINANCIAL TRANSACTION DATA INTO PERSONAL FINANCIAL MANAGEMENT AND BILL PAYMENT SYSTEM PAYMENT DUE DATA ASSOCIATED WITH A PERSONAL FINANCIAL MANAGEMENT AND BILL PAYMENT SYSTEM OPERATION 205 by assigning an initial personal financial management and bill payment system financial transaction category to the discrete invoices represented in the invoice related financial transaction data, such as the “uncategorized” financial transaction category.

In accordance with one embodiment, the invoice related financial transaction data is integrated into personal financial management and bill payment system payment due data associated with a personal financial management and bill payment system at INTEGRATE THE INVOICE RELATED FINANCIAL TRANSACTION DATA INTO PERSONAL FINANCIAL MANAGEMENT AND BILL PAYMENT SYSTEM PAYMENT DUE DATA ASSOCIATED WITH A PERSONAL FINANCIAL MANAGEMENT AND BILL PAYMENT SYSTEM OPERATION 205 by any method, system, process and/or procedure for integrating invoice related financial transaction data into personal financial management and bill payment system payment due data as discussed herein, known in the art at the time of filing, and/or as developed/made available after the time of filing.

In accordance with various embodiments, the invoice related financial transaction data is integrated into personal financial management and bill payment system payment due data associated with a personal financial management and bill payment system at INTEGRATE THE INVOICE RELATED FINANCIAL TRANSACTION DATA INTO PERSONAL FINANCIAL MANAGEMENT AND BILL PAYMENT SYSTEM PAYMENT DUE DATA ASSOCIATED WITH A PERSONAL FINANCIAL MANAGEMENT AND BILL PAYMENT SYSTEM OPERATION 205 by any method, system, process and/or procedure for integrating invoice related financial transaction data into personal financial management and bill payment system payment due data as discussed in: U.S. patent application Ser. No. 15/140,117 (docket number INTU169676), filed on behalf of the same Inventors of the present patent application, filed on Apr. 27, 2016, entitled “METHOD AND SYSTEM FOR PROVIDING INVOICES GENERATED THROUGH A BUSINESS INVOICING SYSTEM TO A CUSTOMER USER OF A PERSONAL FINANCIAL MANAGEMENT AND BILL PAYMENT SYSTEM,” which is herein incorporated by reference in its entirety as if it were fully set forth herein; and/or U.S. patent application Ser. No. 15/140,131 (docket number INTU169677), filed on behalf of the same Inventors of the present patent application, filed on Apr. 27, 2016, entitled “METHOD AND SYSTEM FOR IDENTIFYING INVOICES THAT ARE PAID THROUGH A PERSONAL FINANCIAL MANAGEMENT AND BILL PAYMENT SYSTEM,” which is herein incorporated by reference in its entirety as if it were fully set forth herein; and/or U.S. patent application Ser. No. 15/142,708 (docket number INTU169678), filed on behalf of the same Inventors of the present patent application, filed on Apr. 29, 2016, entitled “METHOD AND SYSTEM FOR INTEGRATING BUSINESS INVOICES INTO A PERSONAL FINANCIAL MANAGEMENT AND BILL PAYMENT SYSTEM,” which is herein incorporated by reference in its entirety as if it were fully set forth herein.

In one embodiment, once the invoice related financial transaction data is integrated into personal financial management and bill payment system payment due data associated with a personal financial management and bill payment system at INTEGRATE THE INVOICE RELATED FINANCIAL TRANSACTION DATA INTO PERSONAL FINANCIAL MANAGEMENT AND BILL PAYMENT SYSTEM PAYMENT DUE DATA ASSOCIATED WITH A PERSONAL FINANCIAL MANAGEMENT AND BILL PAYMENT SYSTEM OPERATION 205, process flow proceeds to OBTAIN ACCESS TO THE PERSONAL FINANCIAL MANAGEMENT AND BILL PAYMENT SYSTEM PAYMENT DUE DATA, INCLUDING THE INTEGRATED INVOICE RELATED FINANCIAL TRANSACTION DATA, AND ADDITIONAL INVOICE RELATED FINANCIAL TRANSACTION DATA OPERATION 207.

In one embodiment, at OBTAIN ACCESS TO THE PERSONAL FINANCIAL MANAGEMENT AND BILL PAYMENT SYSTEM PAYMENT DUE DATA, INCLUDING THE INTEGRATED INVOICE RELATED FINANCIAL TRANSACTION DATA, AND ADDITIONAL INVOICE RELATED FINANCIAL TRANSACTION DATA OPERATION 207, access to the personal financial management and bill payment system and the personal financial management and bill payment system payment due data, including the integrated invoice related financial transaction data, and the additional invoice related financial transaction data of ANALYZE THE ADDITIONAL FIRST INVOICE RELATED FINANCIAL TRANSACTION DATA TO DETERMINE IF THE FIRST DISCRETE INVOICE REPRESENTED IN THE INVOICE RELATED FINANCIAL TRANSACTION DATA IS A TAX RELATED INVOICE HAVING POTENTIAL TAX RAMIFICATIONS OPERATION 209 is obtained.

In one embodiment, at OBTAIN ACCESS TO THE PERSONAL FINANCIAL MANAGEMENT AND BILL PAYMENT SYSTEM PAYMENT DUE DATA, INCLUDING THE INTEGRATED INVOICE RELATED FINANCIAL TRANSACTION DATA, AND ADDITIONAL INVOICE RELATED FINANCIAL TRANSACTION DATA OPERATION 207, one or more processors associated with one or more computing systems are utilized to obtain access to the personal financial management and bill payment system and the personal financial management and bill payment system payment due data, including the integrated invoice related financial transaction data, and the additional invoice related financial transaction data.

In one embodiment, once access to the personal financial management and bill payment system and the personal financial management and bill payment system payment due data, including the integrated invoice related financial transaction data, and the additional invoice related financial transaction data is obtained at OBTAIN ACCESS TO THE PERSONAL FINANCIAL MANAGEMENT AND BILL PAYMENT SYSTEM PAYMENT DUE DATA, INCLUDING THE INTEGRATED INVOICE RELATED FINANCIAL TRANSACTION DATA, AND ADDITIONAL INVOICE RELATED FINANCIAL TRANSACTION DATA OPERATION 207, process flow proceeds to ANALYZE THE ADDITIONAL FIRST INVOICE RELATED FINANCIAL TRANSACTION DATA TO DETERMINE IF THE FIRST DISCRETE INVOICE REPRESENTED IN THE INVOICE RELATED FINANCIAL TRANSACTION DATA IS A TAX RELATED INVOICE HAVING POTENTIAL TAX RAMIFICATIONS OPERATION 209.

In one embodiment, at ANALYZE THE ADDITIONAL FIRST INVOICE RELATED FINANCIAL TRANSACTION DATA TO DETERMINE IF THE FIRST DISCRETE INVOICE REPRESENTED IN THE INVOICE RELATED FINANCIAL TRANSACTION DATA IS A TAX RELATED INVOICE HAVING POTENTIAL TAX RAMIFICATIONS OPERATION 209, additional first invoice related financial transaction data is identified, extracted, and analyzed to determine if the first discrete invoice represented in the invoice related financial transaction data is a tax related invoice having potential tax ramifications.

In accordance with one embodiment, at ANALYZE THE ADDITIONAL FIRST INVOICE RELATED FINANCIAL TRANSACTION DATA TO DETERMINE IF THE FIRST DISCRETE INVOICE REPRESENTED IN THE INVOICE RELATED FINANCIAL TRANSACTION DATA IS A TAX RELATED INVOICE HAVING POTENTIAL TAX RAMIFICATIONS OPERATION 209 the personal financial management and bill payment system and the personal financial management and bill payment system payment due data, including the integrated invoice related financial transaction data, and the additional invoice related financial transaction data of OBTAIN ACCESS TO THE PERSONAL FINANCIAL MANAGEMENT AND BILL PAYMENT SYSTEM PAYMENT DUE DATA, INCLUDING THE INTEGRATED INVOICE RELATED FINANCIAL TRANSACTION DATA, AND ADDITIONAL INVOICE RELATED FINANCIAL TRANSACTION DATA OPERATION 207 is analyzed to identify a first discrete invoice represented in the invoice related financial transaction data that includes additional first invoice related financial transaction data associated with the first discrete invoice represented in the invoice related financial transaction data.

In accordance with one embodiment, the personal financial management and bill payment system and the personal financial management and bill payment system payment due data, including the integrated invoice related financial transaction data, and the additional invoice related financial transaction data is analyzed at ANALYZE THE ADDITIONAL FIRST INVOICE RELATED FINANCIAL TRANSACTION DATA TO DETERMINE IF THE FIRST DISCRETE INVOICE REPRESENTED IN THE INVOICE RELATED FINANCIAL TRANSACTION DATA IS A TAX RELATED INVOICE HAVING POTENTIAL TAX RAMIFICATIONS OPERATION 209 using one or more processors associated with one or more computing systems.

In accordance with one embodiment, additional first invoice related financial transaction data is identified and/or extracted at ANALYZE THE ADDITIONAL FIRST INVOICE RELATED FINANCIAL TRANSACTION DATA TO DETERMINE IF THE FIRST DISCRETE INVOICE REPRESENTED IN THE INVOICE RELATED FINANCIAL TRANSACTION DATA IS A TAX RELATED INVOICE HAVING POTENTIAL TAX RAMIFICATIONS OPERATION 209.

In accordance with one embodiment, the additional first invoice related financial transaction data of ANALYZE THE ADDITIONAL FIRST INVOICE RELATED FINANCIAL TRANSACTION DATA TO DETERMINE IF THE FIRST DISCRETE INVOICE REPRESENTED IN THE INVOICE RELATED FINANCIAL TRANSACTION DATA IS A TAX RELATED INVOICE HAVING POTENTIAL TAX RAMIFICATIONS OPERATION 209 includes Level-3 data associated with at least one discrete invoice represented in the invoice related financial transaction data and provides additional transaction details, and/or information, associated with the at least one discrete invoice represented in the invoice related financial transaction data.

As noted above, Level-3 financial transaction data includes data indicating not only the payee, payor, amount, and date of the financial transaction, but also line item listing data representing the item actually purchased, and the amount paid for each item listed. Specific examples/fields of Level-3 data include, but are not limited to: Quantity data; Item ID or SKU; Item description; Unit price; Extended price; Unit of measure (each); Commodity code; Line discount; Ship-From Zip Code; Destination Zip Code; Invoice Number; Item Extended Amount; Freight Amount; Duty Amount, etc. Consequently, Level-3 data is the most desired and informative/useful type of financial transaction data, particularly for identifying tax related financial transactions.

However, as also noted above, absent invoice related financial transaction data, Level-3 data is often difficult to obtain and often requires special equipment and permissions. For instance, historically, when Level-3 data is obtained from traditional sources, such as credit card financial transactions, bill payments, and point-of-sale systems, there have been significant obstacles for businesses wanting to provide and/or obtain Level-3 data. The most obvious is that card terminals do not typically prompt for the additional financial transaction related data, and if they did, data would be manually entered from a numeric keypad. Consequently, businesses who want to obtain, supply, and process Level-3 data need to input their transaction information from specialized point-of-sale software systems that prompt them for the required information.

As a result, absent the disclosed embodiment, most businesses will never have the opportunity to obtain and/or accept Level-3 data in any traditional way. Therefore, invoice related financial transaction data represents a valuable opportunity to obtain Level-3 data in a potentially simple, efficient, and cost effective way, without requiring special processes, systems, equipment, and permissions. However, using the disclosed embodiments, Level-3 data associated with at least one discrete invoice represented in the invoice related financial transaction data is identified, extracted, and/or otherwise obtained at ANALYZE THE ADDITIONAL FIRST INVOICE RELATED FINANCIAL TRANSACTION DATA TO DETERMINE IF THE FIRST DISCRETE INVOICE REPRESENTED IN THE INVOICE RELATED FINANCIAL TRANSACTION DATA IS A TAX RELATED INVOICE HAVING POTENTIAL TAX RAMIFICATIONS OPERATION 209.

In accordance with one embodiment, the additional first invoice related financial transaction data of ANALYZE THE ADDITIONAL FIRST INVOICE RELATED FINANCIAL TRANSACTION DATA TO DETERMINE IF THE FIRST DISCRETE INVOICE REPRESENTED IN THE INVOICE RELATED FINANCIAL TRANSACTION DATA IS A TAX RELATED INVOICE HAVING POTENTIAL TAX RAMIFICATIONS OPERATION 209 includes additional input data to one or more payor users associated with at least one discrete invoice represented in the invoice related financial transaction data of the personal financial management and bill payment system from one or more business payees associated with at least one discrete invoice represented in the invoice related financial transaction data.

In accordance with one embodiment, the additional first invoice related financial transaction data of ANALYZE THE ADDITIONAL FIRST INVOICE RELATED FINANCIAL TRANSACTION DATA TO DETERMINE IF THE FIRST DISCRETE INVOICE REPRESENTED IN THE INVOICE RELATED FINANCIAL TRANSACTION DATA IS A TAX RELATED INVOICE HAVING POTENTIAL TAX RAMIFICATIONS OPERATION 209 includes additional input data from one or more payor users associated with at least one discrete invoice represented in the invoice related financial transaction data of the personal financial management and bill payment system to one or more business payees associated with at least one discrete invoice represented in the invoice related financial transaction data.

In various embodiments, this additional input data representing notes and/or input added to the invoices represented in the invoice related financial transaction data includes various additional invoice related financial transaction data that can be identified, extracted, and utilized as described below.

In accordance with one embodiment, at ANALYZE THE ADDITIONAL FIRST INVOICE RELATED FINANCIAL TRANSACTION DATA TO DETERMINE IF THE FIRST DISCRETE INVOICE REPRESENTED IN THE INVOICE RELATED FINANCIAL TRANSACTION DATA IS A TAX RELATED INVOICE HAVING POTENTIAL TAX RAMIFICATIONS OPERATION 209 the additional first invoice related financial transaction data is identified, extracted, and analyzed to determine if the first discrete invoice represented in the invoice related financial transaction data is a tax related invoice having potential tax ramifications.

As noted above, herein, the term “tax related invoice” includes any invoice associated with a financial transaction, i.e., requesting and/or resulting in, a transfer or re-categorization of funds, that includes a transfer or re-categorization of funds that has potential tax ramifications to a user, i.e., has a potential for resulting in tax consequences for the user and/or to potentially cause a change in the user's tax liability.

Examples of tax related invoices include, but are not limited to; invoices for home repair and/or home improvement work; invoices for child care; invoices associated with charitable donations and projects; invoices associated with healthcare; invoices associated with business automobile travel; invoices associated with business expenses; invoices associated with business travel; invoices associated with business related computing systems, office equipment, and/or office/business electronics; invoices for professional services related to a business; and/or any other invoices requesting and/or resulting in, a transfer or re-categorization of funds, that includes a transfer or re-categorization of funds that has potential tax ramifications to a user, i.e., has a potential for resulting in tax consequences for the user and/or to potentially cause a change in the user's tax liability.

In accordance with one embodiment, once additional first invoice related financial transaction data is identified, extracted, and analyzed to determine if the first discrete invoice represented in the invoice related financial transaction data is a tax related invoice having potential tax ramifications at ANALYZE THE ADDITIONAL FIRST INVOICE RELATED FINANCIAL TRANSACTION DATA TO DETERMINE IF THE FIRST DISCRETE INVOICE REPRESENTED IN THE INVOICE RELATED FINANCIAL TRANSACTION DATA IS A TAX RELATED INVOICE HAVING POTENTIAL TAX RAMIFICATIONS OPERATION 209, process flow proceeds to DETERMINE THAT THE FIRST DISCRETE INVOICE REPRESENTED IN THE INVOICE RELATED FINANCIAL TRANSACTION DATA IS A TAX RELATED INVOICE HAVING POTENTIAL TAX RAMIFICATIONS OPERATION 211.

In one embodiment, at DETERMINE THAT THE FIRST DISCRETE INVOICE REPRESENTED IN THE INVOICE RELATED FINANCIAL TRANSACTION DATA IS A TAX RELATED INVOICE HAVING POTENTIAL TAX RAMIFICATIONS OPERATION 211 based, at least in part, on the analysis of the additional invoice related financial transaction data at ANALYZE THE ADDITIONAL FIRST INVOICE RELATED FINANCIAL TRANSACTION DATA TO DETERMINE IF THE FIRST DISCRETE INVOICE REPRESENTED IN THE INVOICE RELATED FINANCIAL TRANSACTION DATA IS A TAX RELATED INVOICE HAVING POTENTIAL TAX RAMIFICATIONS OPERATION 209, a determination is made that the first discrete invoice represented in the invoice related financial transaction data is a tax related invoice having potential tax ramifications.

In one embodiment, once a determination is made that the first discrete invoice represented in the invoice related financial transaction data is a tax related invoice having potential tax ramifications at DETERMINE THAT THE FIRST DISCRETE INVOICE REPRESENTED IN THE INVOICE RELATED FINANCIAL TRANSACTION DATA IS A TAX RELATED INVOICE HAVING POTENTIAL TAX RAMIFICATIONS OPERATION 211, process flow proceeds to TRANSFORM FIRST INVOICE STATUS DATA ASSOCIATED WITH THE FIRST DISCRETE INVOICE REPRESENTED IN THE INVOICE RELATED FINANCIAL TRANSACTION DATA TO TAX RELATED INVOICE STATUS DATA OPERATION 213.

In one embodiment, at TRANSFORM FIRST INVOICE STATUS DATA ASSOCIATED WITH THE FIRST DISCRETE INVOICE REPRESENTED IN THE INVOICE RELATED FINANCIAL TRANSACTION DATA TO TAX RELATED INVOICE STATUS DATA OPERATION 213, first invoice status data associated with the first discrete invoice represented in the invoice related financial transaction data is transformed into tax related invoice status data.

In one embodiment, once first invoice status data associated with the first discrete invoice represented in the invoice related financial transaction data is transformed into tax related invoice status data at TRANSFORM FIRST INVOICE STATUS DATA ASSOCIATED WITH THE FIRST DISCRETE INVOICE REPRESENTED IN THE INVOICE RELATED FINANCIAL TRANSACTION DATA TO TAX RELATED INVOICE STATUS DATA OPERATION 213, the user of the personal financial management and bill payment system is provided the opportunity to review and/or approve the tax related invoice status data of the first discrete invoice represented in the invoice related financial transaction data.

In one embodiment, once first invoice status data associated with the first discrete invoice represented in the invoice related financial transaction data is transformed into tax related invoice status data at TRANSFORM FIRST INVOICE STATUS DATA ASSOCIATED WITH THE FIRST DISCRETE INVOICE REPRESENTED IN THE INVOICE RELATED FINANCIAL TRANSACTION DATA TO TAX RELATED INVOICE STATUS DATA OPERATION 213, process flow proceeds to PROCESS THE PORTION OF THE INVOICE RELATED FINANCIAL TRANSACTION DATA REPRESENTING THE FIRST DISCRETE INVOICE AS TAX RELATED INVOICE FINANCIAL TRANSACTION DATA OPERATION 215.

In one embodiment, at PROCESS THE PORTION OF THE INVOICE RELATED FINANCIAL TRANSACTION DATA REPRESENTING THE FIRST DISCRETE INVOICE AS TAX RELATED INVOICE FINANCIAL TRANSACTION DATA OPERATION 215, the portion of the invoice related financial transaction data of INTEGRATE THE INVOICE RELATED FINANCIAL TRANSACTION DATA INTO PERSONAL FINANCIAL MANAGEMENT AND BILL PAYMENT SYSTEM PAYMENT DUE DATA ASSOCIATED WITH A PERSONAL FINANCIAL MANAGEMENT AND BILL PAYMENT SYSTEM OPERATION 205 representing the first discrete invoice of ANALYZE THE ADDITIONAL FIRST INVOICE RELATED FINANCIAL TRANSACTION DATA TO DETERMINE IF THE FIRST DISCRETE INVOICE REPRESENTED IN THE INVOICE RELATED FINANCIAL TRANSACTION DATA IS A TAX RELATED INVOICE HAVING POTENTIAL TAX RAMIFICATIONS OPERATION 209 is processed as tax related invoice financial transaction data.

In accordance with one embodiment, at PROCESS THE PORTION OF THE INVOICE RELATED FINANCIAL TRANSACTION DATA REPRESENTING THE FIRST DISCRETE INVOICE AS TAX RELATED INVOICE FINANCIAL TRANSACTION DATA OPERATION 215 the portion of the invoice related financial transaction data representing the first discrete invoice is processed as tax related invoice financial transaction data using the personal financial management and bill payment system of OBTAIN ACCESS TO THE PERSONAL FINANCIAL MANAGEMENT AND BILL PAYMENT SYSTEM PAYMENT DUE DATA, INCLUDING THE INTEGRATED INVOICE RELATED FINANCIAL TRANSACTION DATA, AND ADDITIONAL INVOICE RELATED FINANCIAL TRANSACTION DATA OPERATION 207.

In accordance with one embodiment, at PROCESS THE PORTION OF THE INVOICE RELATED FINANCIAL TRANSACTION DATA REPRESENTING THE FIRST DISCRETE INVOICE AS TAX RELATED INVOICE FINANCIAL TRANSACTION DATA OPERATION 215 the portion of the invoice related financial transaction data representing the first discrete invoice is processed as tax related invoice financial transaction by assigning a tax category to the portion of the invoice related financial transaction data representing the first discrete invoice. In one embodiment, the assigned tax category is defined by one or more local, state, or federal tax agencies.

In accordance with one embodiment, at PROCESS THE PORTION OF THE INVOICE RELATED FINANCIAL TRANSACTION DATA REPRESENTING THE FIRST DISCRETE INVOICE AS TAX RELATED INVOICE FINANCIAL TRANSACTION DATA OPERATION 215 the portion of the invoice related financial transaction data representing the first discrete invoice is processed as tax related invoice financial transaction data by providing a copy of the portion of the invoice related financial transaction data representing the first discrete invoice to a tax preparation and filing system for processing as tax related invoice financial transaction data.

As noted above, the terms “tax preparation system,” “tax filing system,” “tax return preparation and filing system,” and “tax preparation and filing system,” are used interchangeably and include, but are not limited to, the following: computing system, desktop system, mobile system, and/or wearable device implemented, and/or online, and/or web-based, storage based, persistence based, tax preparation and filing and/or processing systems, services, packages, programs, modules, or applications; and various other tax preparation and filing systems, services, packages, programs, modules, or applications, used to process and/or facilitate the filing of electronic tax and/or hardcopy tax return documents, whether known at the time of filling, or as developed later.

Specific examples of personal financial management and bill payment systems include, but are not limited to TurboTax™ available from Intuit, Inc. of Mountain View, Calif.; TurboTax Online™ available from Intuit, Inc. of Mountain View, Calif.; and/or various other software systems discussed herein, and/or known to those of skill in the art at the time of filing, and/or as developed after the time of filing.

Currently, personal financial management and bill payment systems, business invoicing systems, and tax preparation systems are typically distinct software systems operated and/or used by at least two distinct parties, e.g., a customer of a business and an owner of a business, respectively. Currently, personal financial management and bill payment systems, business invoicing systems, and tax preparation systems typically operate in isolation from each other, even when they are offered by the same personal financial management and bill payment systems, business invoicing systems, and tax preparation systems provider.

As a specific illustrative example, in one embodiment, the personal financial management and bill payment system used by a customer of a business, or other user, could be a personal financial transaction management system such as Mint™, available from Intuit, Inc. of Mountain View, Calif. In this specific illustrative example, a business invoicing system, used by a business user, could be a business invoicing system such as QuickBooks™, available from Intuit, Inc. of Mountain View, Calif. In this specific illustrative example, a tax preparation system, used by a business user, a customer of a business, or other user, could be a tax preparation system such as TurboTax™, available from Intuit, Inc. of Mountain View, Calif. As seen in this specific illustrative example, the personal financial management and bill payment system, the business invoicing system, and the tax preparation system are offered by the same software system provider, i.e., in this specific case, Intuit, Inc. of Mountain View, Calif.

Consequently, according to one embodiment, personal financial management and bill payment system of INTEGRATE THE INVOICE RELATED FINANCIAL TRANSACTION DATA INTO PERSONAL FINANCIAL MANAGEMENT AND BILL PAYMENT SYSTEM PAYMENT DUE DATA ASSOCIATED WITH A PERSONAL FINANCIAL MANAGEMENT AND BILL PAYMENT SYSTEM OPERATION 205, the business invoicing system of OBTAIN ACCESS TO INVOICE RELATED FINANCIAL TRANSACTION DATA REPRESENTING TWO OR MORE DISCRETE INVOICES, THE INVOICE RELATED FINANCIAL TRANSACTION DATA INCLUDING ADDITIONAL INVOICE RELATED FINANCIAL TRANSACTION DATA OPERATION 203, and, in one embodiment, the tax preparation system of PROCESS THE PORTION OF THE INVOICE RELATED FINANCIAL TRANSACTION DATA REPRESENTING THE FIRST DISCRETE INVOICE AS TAX RELATED INVOICE FINANCIAL TRANSACTION DATA OPERATION 215, are provided the opportunity to share, “cross-pollinate,” and cross-confirm supported data. This approach has several unique advantages and significantly enhances the user experience associated with all three systems.

In one embodiment, once the portion of the invoice related financial transaction data of INTEGRATE THE INVOICE RELATED FINANCIAL TRANSACTION DATA INTO PERSONAL FINANCIAL MANAGEMENT AND BILL PAYMENT SYSTEM PAYMENT DUE DATA ASSOCIATED WITH A PERSONAL FINANCIAL MANAGEMENT AND BILL PAYMENT SYSTEM OPERATION 205 representing the first discrete invoice of ANALYZE THE ADDITIONAL FIRST INVOICE RELATED FINANCIAL TRANSACTION DATA TO DETERMINE IF THE FIRST DISCRETE INVOICE REPRESENTED IN THE INVOICE RELATED FINANCIAL TRANSACTION DATA IS A TAX RELATED INVOICE HAVING POTENTIAL TAX RAMIFICATIONS OPERATION 209 is processed as tax related invoice financial transaction data at PROCESS THE PORTION OF THE INVOICE RELATED FINANCIAL TRANSACTION DATA REPRESENTING THE FIRST DISCRETE INVOICE AS TAX RELATED INVOICE FINANCIAL TRANSACTION DATA OPERATION 215, process flow proceeds to EXIT OPERATION 230.

In one embodiment, at EXIT OPERATION 230, process 200 for integrating invoice related financial transaction data into a personal financial management and bill payment system to more accurately identify and categorize tax related financial transactions is exited to await new data.

The disclosed embodiments of process 200 for integrating invoice related financial transaction data into a personal financial management and bill payment system to more accurately identify and categorize tax related financial transactions provide an efficient, effective, and highly adaptable solution to the long standing technical need in the bill payment, invoice processing, tax preparation and filing, and financial management arts for automatically integrating invoice related financial transaction data into a personal financial management and bill payment system, and/or obtaining, identifying, or distinguishing, invoice related financial transaction data, processing the integrated invoice related financial transaction data to extract additional invoice related financial transaction data, such as Level-3 financial transaction data, included in the invoice related financial transaction data, and then using the additional invoice related financial transaction data to more accurately and automatically identify tax related financial transactions for processing as tax related financial transactions having tax ramifications.

However, process 200 for integrating invoice related financial transaction data into a personal financial management and bill payment system to more accurately identify and categorize tax related financial transactions does not encompass, embody, or preclude other forms of innovation in the area of automated financial transaction bill payment, processing, and reporting, and/or tax return preparation and filing. In addition, process 200 for integrating invoice related financial transaction data into a personal financial management and bill payment system to more accurately identify and categorize tax related financial transactions is not related to any fundamental economic practice, fundamental data processing practice, mental steps, or pen and paper based solution. In fact, the disclosed embodiments are directed to providing solutions to the relatively new problems associated with the automatic processing and display of electronic financial transaction data obtained from multiple sources, making electronic bill payments and determining tax liabilities, and the management and processing of large amounts of data, i.e., “big data.” Consequently, process 200 for integrating invoice related financial transaction data into a personal financial management and bill payment system to more accurately identify and categorize tax related financial transactions is not directed to, does not encompass, and is not merely, an abstract idea or concept.

In addition, process 200 for integrating invoice related financial transaction data into a personal financial management and bill payment system to more accurately identify and categorize tax related financial transactions provides for significant improvements to the technical fields of electronic transaction data processing, tax return preparation, invoice processing, financial transaction categorization, information dissemination, data processing, data management, data filtering and mining, automatic electronic bill payment, and user experience.

In addition, by allowing for the integration of invoices and invoice data into a personal financial management and bill payment system, process 200 for integrating invoice related financial transaction data into a personal financial management and bill payment system to more accurately identify and categorize tax related financial transactions helps users of the personal financial management and bill payment system identify and pay their invoices and taxes. This, in turn, helps avoid the reissuance and repeated transmission of payment and tax due reminders and for the entry, processing, and dissemination, of redundant invoice and tax data; thereby eliminating unnecessary data analysis before resources are allocated to processing, and/or correcting, redundant data and the redundant data is further transmitted/distributed.

In addition process 200 for integrating invoice related financial transaction data into a personal financial management and bill payment system to more accurately identify and categorize tax related financial transactions provides for the entry, processing, and dissemination, of only relevant portions of tax related data; thereby eliminating unnecessary data analysis and correction before resources are allocated to processing, and/or correcting, faulty/irrelevant data, and/or the faulty/irrelevant data is further transmitted/distributed.

Consequently, using process 200 for integrating invoice related financial transaction data into a personal financial management and bill payment system to more accurately identify and categorize tax related financial transactions results in more efficient use of human and non-human resources, fewer processor cycles being utilized, reduced memory utilization, and less communications bandwidth being utilized to relay data to, and from, backend systems and client systems.

As a result, computing systems are transformed into faster, more efficient, and more effective computing systems by implementing process 200 for integrating invoice related financial transaction data into a personal financial management and bill payment system to more accurately identify and categorize tax related financial transactions.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, and/or protocols. Further, the system and/or functionality of the invention may be implemented via various combinations of software and hardware, as described, or entirely in hardware elements. Also, particular divisions of functionality between the various components described herein, are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic and/or algorithm-like descriptions and representations are the mechanism and/or process used by those of skill in the art to most effectively and efficiently convey the substance of their work to others of skill in the art. These operations, while described functionally or logically, are understood to be implemented by computer programs and/or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as “integrating,” “generating,” “monitoring,” “determining,” “defining,” “designating,” “obtaining,” “accessing,” “analyzing,” “obtaining,” “identifying,” “designating,” categorizing,” “receiving,” “transmitting,” “implementing,” “associating,” “aggregating,” “initiating,” “collecting,” “creating,” “transferring,” “storing,” “searching,” “comparing,” “providing,” “transforming,” “incorporating.” “processing” etc., refer to the action and processes of a computing system or similar electronic device that manipulates and operates on data represented as physical (electronic) quantities within the computing system memories, resisters, caches or other information storage, transmission or display devices.

Certain aspects of the present invention include process steps or operations and instructions described herein in an algorithmic and/or algorithmic-like form. It should be noted that the process steps and/or operations and instructions of the present invention can be embodied in software, firmware, and/or hardware, and when embodied in software, can be downloaded to reside on and be operated from different platforms used by real time network operating systems.

The present invention also relates to an apparatus or system for performing the operations described herein. This apparatus or system may be specifically constructed for the required purposes by a computer program stored via a computer program product as defined herein that can be accessed by a computing system or other device to transform the computing system or other device into a specifically and specially programmed computing system or other device.

Those of skill in the art will readily recognize that the algorithms and operations presented herein are not inherently related to any particular computing system, computer architecture, computer or industry standard, or any other specific apparatus. It may prove convenient/efficient to construct or transform one or more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

The present invention is well suited to a wide variety of computer network systems operating over numerous topologies. Within this field, the configuration and management of large networks comprise storage devices and computers that are communicatively coupled to similar and/or dissimilar computers and storage devices over a private network, a LAN, a WAN, a private network, or a public network, such as the Internet.

It should also be noted that the language used in the specification has been principally selected for readability, clarity, and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIG.s are identified using a particular nomenclature for ease of description and understanding, but other nomenclature is often used in the art to identify equivalent operations.

In the discussion above, certain aspects of one embodiment include process steps and/or operations and/or instructions described herein for illustrative purposes in a particular order and/or grouping. However, the particular order and/or grouping shown and discussed herein is illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein does not limit the scope of the invention as claimed below.

Therefore, numerous variations, whether explicitly provided for by the specification or implied by the specification or not, may be implemented by one of skill in the art in view of this disclosure.

What is claimed is:

1. A method for integrating invoice related financial transaction data into a personal financial management and bill payment system to more accurately identify and categorize tax related financial transactions, the method comprising:
obtaining access to invoice related financial transaction data generated by the one or more payee businesses, the invoice related financial transaction data representing two or more discrete invoices submitted by one or more payee businesses requesting payment by one or more payor users of the personal financial management and bill payment system, the invoice related financial transaction data including:
payee business identity data associated with each discrete invoice represented in the invoice related financial transaction data, the payee business identity data representing the identity of the payee business associated with each discrete invoice represented in the invoice related financial transaction data;
payor user identity data associated with each discrete invoice represented in the invoice related financial transaction data, the payor user identity data representing the identity of the payor user associated with each discrete invoice represented in the invoice related financial transaction data;
invoice amount data associated with each discrete invoice represented in the invoice related financial transaction data, the invoice amount data representing the payment amount associated with each discrete invoice represented in the invoice related financial transaction data; and
additional invoice related financial transaction data, the additional invoice related financial transaction data being associated with at least one discrete invoice represented in the invoice related financial transaction data and providing additional transaction details, and/or information, associated with the at least one discrete invoice represented in the invoice related financial transaction data;
integrating the invoice related financial transaction data into personal financial management and bill payment system payment due data associated with a personal financial management and bill payment system, the personal financial management and bill payment system payment due data representing one or more bills associated with one or more users of the personal financial management and bill payment system to be paid through the personal financial management and bill payment system;
obtaining access to the personal financial management and bill payment system;
obtaining access to the personal financial management and bill payment system payment due data, including the integrated invoice related financial transaction data;
obtaining access to additional first invoice related financial transaction data associated with a first discrete invoice represented in the invoice related financial transaction data;
analyzing the additional first invoice related financial transaction data to determine if the first discrete invoice represented in the invoice related financial transaction data is a tax related invoice having potential tax ramifications;
determining that the first discrete invoice represented in the invoice related financial transaction data is a tax related invoice having potential tax ramifications;
transforming first invoice status data associated with the first discrete invoice represented in the invoice related financial transaction data to tax related invoice status data; and
processing the portion of the invoice related financial transaction data representing the first discrete invoice as tax related invoice financial transaction data.

2. The method for integrating invoice related financial transaction data into a personal financial management and bill payment system to more accurately identify and categorize tax related financial transactions of claim 1 wherein obtaining access to invoice related financial transaction data generated by the one or more payee businesses includes:
obtaining access to personal financial management and bill payment system user financial transaction data associated with the personal financial management and bill payment system, the personal financial management and bill payment system user financial transaction data representing financial transactions associated with users of a personal financial management and bill payment system;
analyzing the personal financial management and bill payment system user financial transaction data associated with the first payor user to identify payee data included in the financial transaction data associated with a first payor user, the payee data representing one or more payees associated with first payor user financial transactions associated with the first payor user represented by a portion of the personal financial management and bill payment system user financial transaction data associated with the first payor user;
obtaining access to business invoicing system business user identification data associated with a business invoicing system, the business user identification data representing business users of the business invoicing system;
accessing the payee data and the business user identification data and analyzing the payee data and business user identification data to determine if a payee represented in the payee data matches a business user of the business invoicing system represented in the business user identification data;
identifying a payee represented in the payee data that matches a business user of the business invoicing system represented in the business user identification data, the payee being a payee associated with first financial transaction data representing a first financial transaction included in the personal financial management and bill payment system user financial transaction data associated with the first payor user;
designating the payee represented in the payee data that matches the business user of the business invoicing system as a first payee business;
transforming status data associated with the first financial transaction data representing the first financial transaction to first invoice related financial transaction data;
processing the first invoice related financial transaction data as invoice related financial transaction data; and
providing the first payee business the capability to provide invoicing data representing invoices generated by first payee business to the first payor user of the personal financial management and bill payment system through the personal financial management and bill payment system.

3. The method for integrating invoice related financial transaction data into a personal financial management and bill payment system to more accurately identify and categorize tax related financial transactions of claim 1 wherein obtaining access to invoice related financial transaction data generated by the one or more payee businesses includes:
obtaining access to personal financial management and bill payment system user identification data associated with users of a personal financial management and bill payment system;
obtaining access to invoicing data generated through a business invoicing system, the invoicing data representing invoices sent from payee business users of the business invoicing system to payor customers of the payee business users of the business invoicing system;
monitoring the invoicing data and identifying first invoice data representing an invoice generated by a first payee business user of the business invoicing system associated with a first payor customer of the first payee business user of the business invoicing system;
analyzing the first invoice data to identify first payor customer identification data associated with the first payor customer of the first payee business user of the business invoicing system;
analyzing the personal financial management and bill payment system user identification data and the first payor customer identification data to determine if the first payor customer associated with the first payor customer identification data is a first payor user of the personal financial management and bill payment system; and
if a determination is made that the first payor customer associated with the first payor customer identification data is a first payor user of the personal financial management and bill payment system, designating the first payor customer as a first payor user of the personal financial management and bill payment system;
providing the first payee business user of the business invoicing system the capability to provide invoicing data representing invoices generated by the first payee business user of the business invoicing system to the first payor user of the personal financial management and bill payment system through the personal financial management and bill payment system.

4. The method for integrating invoice related financial transaction data into a personal financial management and bill payment system to more accurately identify and categorize tax related financial transactions of claim 1 wherein obtaining access to invoice related financial transaction data generated by the one or more payee businesses includes:
obtaining access to personal financial management and bill payment system user identification data associated with users of a personal financial management and bill payment system;
obtaining access to business invoicing system payor customer identification data generated through a business invoicing system, the business invoicing system payor customer identification data being associated with payor customers of user payee businesses of a business invoicing system;
analyzing the personal financial management and bill payment system user identification data and the business invoicing system payor customer identification data to identify payor users of the personal financial management and bill payment system that are payor customers of business users of the business invoicing system;
identifying a payor user of the personal financial management and bill payment system that is a payor customer of a payee business user of the business invoicing system;
designating the payor user of the personal financial management and bill payment system first payor user of the personal financial management and bill payment system;
providing first payor user of the personal financial management and bill payment system the opportunity to integrate invoices generated by the first payee business user of the business invoicing system into the personal financial management and bill payment system; and
if the first payor user of the personal financial management and bill payment system agrees to integrate invoices generated by the first payee business user of the business invoicing system into the personal financial management and bill payment system, providing the first payee business user of the business invoicing system the capability to provide invoice data representing invoices generated by the first payee business user of the business invoicing system to the first payor user of the personal financial management and bill payment system through the personal financial management and bill payment system.

5. The method for integrating invoice related financial transaction data into a personal financial management and bill payment system to more accurately identify and categorize tax related financial transactions of claim 1 wherein the personal financial management and bill payment system is a financial transaction management and billing system through which a user of the financial transaction management and billing system is provided the capability to categorize financial transactions and pay the user's bills.

6. The method for integrating invoice related financial transaction data into a personal financial management and bill payment system to more accurately identify and categorize tax related financial transactions of claim 1 wherein the additional invoice related financial transaction data includes Level-3 data associated with at least one discrete invoice represented in the invoice related financial transaction data and provides additional transaction details, and/or information, associated with the at least one discrete invoice represented in the invoice related financial transaction data.

7. The method for integrating invoice related financial transaction data into a personal financial management and bill payment system to more accurately identify and categorize tax related financial transactions of claim 1 wherein the additional invoice related financial transaction data includes additional input data to one or more payor users associated with at least one discrete invoice represented in the invoice related financial transaction data of the personal financial management and bill payment system from one or more business payees associated with at least one discrete invoice represented in the invoice related financial transaction data.

8. The method for integrating invoice related financial transaction data into a personal financial management and bill payment system to more accurately identify and categorize tax related financial transactions of claim 1 wherein the additional invoice related financial transaction data includes additional input data from one or more payor users associated with at least one discrete invoice represented in the invoice related financial transaction data of the personal financial management and bill payment system to one or more business payees associated with at least one discrete invoice represented in the invoice related financial transaction data.

9. The method for integrating invoice related financial transaction data into a personal financial management and bill payment system to more accurately identify and categorize tax related financial transactions of claim 1 wherein integrating the invoice related financial transaction data into personal financial management and bill payment system payment due data associated with a personal financial management and bill payment system includes providing the discrete invoices represented in the invoice related financial transaction data as line items in a payment due or other financial transaction listing generated through the personal financial management and bill payment system.

10. The method for integrating invoice related financial transaction data into a personal financial management and bill payment system to more accurately identify and categorize tax related financial transactions of claim 1 wherein processing the portion of the invoice related financial transaction data representing the first discrete invoice as tax related invoice financial transaction data includes providing a copy of the portion of the invoice related financial transaction data representing the first discrete invoice to a tax preparation and filing system for processing as tax related invoice financial transaction data.

11. The method for integrating invoice related financial transaction data into a personal financial management and bill payment system to more accurately identify and categorize tax related financial transactions of claim 1 wherein processing the portion of the invoice related financial transaction data representing the first discrete invoice as tax related invoice financial transaction data includes assigning a tax category to the portion of the invoice related financial transaction data representing the first discrete invoice.

12. A system for integrating invoice related financial transaction data into a personal financial management and bill payment system to more accurately identify and categorize tax related financial transactions, the method comprising:
an invoice related financial transaction data acquisition module for obtaining access to invoice related financial transaction data generated by the one or more payee businesses, the invoice related financial transaction data representing two or more discrete invoices submitted by one or more payee businesses requesting payment by one or more payor users of the personal financial management and bill payment system, the invoice related financial transaction data including:
payee business identity data associated with each discrete invoice represented in the invoice related financial transaction data, the payee business identity data representing the identity of the payee business associated with each discrete invoice represented in the invoice related financial transaction data;
payor user identity data associated with each discrete invoice represented in the invoice related financial transaction data, the payor user identity data representing the identity of the payor user associated with each discrete invoice represented in the invoice related financial transaction data;
invoice amount data associated with each discrete invoice represented in the invoice related financial transaction data, the invoice amount data representing the payment amount associated with each discrete invoice represented in the invoice related financial transaction data; and
additional invoice related financial transaction data, the additional invoice related financial transaction data being associated with at least one discrete invoice represented in the invoice related financial transaction data and providing additional transaction details, and/or information, associated with the at least one discrete invoice represented in the invoice related financial transaction data;
an integration module for integrating the invoice related financial transaction data into personal financial management and bill payment system payment due data associated with a personal financial management and bill payment system, the personal financial management and bill payment system payment due data representing one or more bills associated with one or more users of the personal financial management and bill payment system to be paid through the personal financial management and bill payment system;
a personal financial management and bill payment system access module for obtaining access to the personal financial management and bill payment system and the personal financial management and bill payment system payment due data, including the integrated invoice related financial transaction data and additional first invoice related financial transaction data;
a first invoice related financial transaction data acquisition module for identifying and obtaining additional first invoice related financial transaction data associated with a first discrete invoice represented in the invoice related financial transaction data;
an analysis module for analyzing the additional first invoice related financial transaction data to determine if the first discrete invoice represented in the invoice related financial transaction data is a tax related invoice having potential tax ramifications;
a tax status transformation module for transforming first invoice status data associated with the first discrete invoice represented in the invoice related financial transaction data to tax related invoice status data if analysis module determines that the first discrete invoice represented in the invoice related financial transaction data is a tax related invoice having potential tax ramifications.

13. The system for integrating invoice related financial transaction data into a personal financial management and bill payment system to more accurately identify and categorize tax related financial transactions of claim 12 wherein obtaining access to invoice related financial transaction data generated by the one or more payee businesses includes:
obtaining access to personal financial management and bill payment system user financial transaction data associated with the personal financial management and bill payment system, the personal financial management and bill payment system user financial transaction data representing financial transactions associated with users of a personal financial management and bill payment system;
analyzing the personal financial management and bill payment system user financial transaction data associated with the first payor user to identify payee data included in the financial transaction data associated with a first payor user, the payee data representing one or more payees associated with first payor user financial transactions associated with the first payor user represented by a portion of the personal financial management and bill payment system user financial transaction data associated with the first payor user;
obtaining access to business invoicing system business user identification data associated with a business invoicing system, the business user identification data representing business users of the business invoicing system;
accessing the payee data and the business user identification data and analyzing the payee data and business user identification data to determine if a payee represented in the payee data matches a business user of the business invoicing system represented in the business user identification data;
identifying a payee represented in the payee data that matches a business user of the business invoicing system represented in the business user identification data, the payee being a payee associated with first financial transaction data representing a first financial transaction included in the personal financial management and bill payment system user financial transaction data associated with the first payor user;
designating the payee represented in the payee data that matches the business user of the business invoicing system as a first payee business;
transforming status data associated with the first financial transaction data representing the first financial transaction to first invoice related financial transaction data;
processing the first invoice related financial transaction data as invoice related financial transaction data; and
providing the first payee business the capability to provide invoicing data representing invoices generated by first payee business to the first payor user of the personal financial management and bill payment system through the personal financial management and bill payment system.

14. The system for integrating invoice related financial transaction data into a personal financial management and bill payment system to more accurately identify and categorize tax related financial transactions of claim 12 wherein obtaining access to invoice related financial transaction data generated by the one or more payee businesses includes:
obtaining access to personal financial management and bill payment system user identification data associated with users of a personal financial management and bill payment system;
obtaining access to invoicing data generated through a business invoicing system, the invoicing data representing invoices sent from payee business users of the business invoicing system to payor customers of the payee business users of the business invoicing system;
monitoring the invoicing data and identifying first invoice data representing an invoice generated by a first payee business user of the business invoicing system associated with a first payor customer of the first payee business user of the business invoicing system;
analyzing the first invoice data to identify first payor customer identification data associated with the first payor customer of the first payee business user of the business invoicing system;
analyzing the personal financial management and bill payment system user identification data and the first payor customer identification data to determine if the first payor customer associated with the first payor customer identification data is a first payor user of the personal financial management and bill payment system; and
if a determination is made that the first payor customer associated with the first payor customer identification data is a first payor user of the personal financial management and bill payment system, designating the first payor customer as a first payor user of the personal financial management and bill payment system;
providing the first payee business user of the business invoicing system the capability to provide invoicing data representing invoices generated by the first payee business user of the business invoicing system to the first payor user of the personal financial management and bill payment system through the personal financial management and bill payment system.

15. The system for integrating invoice related financial transaction data into a personal financial management and bill payment system to more accurately identify and categorize tax related financial transactions of claim 12 wherein obtaining access to invoice related financial transaction data generated by the one or more payee businesses includes:
obtaining access to personal financial management and bill payment system user identification data associated with users of a personal financial management and bill payment system;
obtaining access to business invoicing system payor customer identification data generated through a business invoicing system, the business invoicing system payor customer identification data being associated with payor customers of user payee businesses of a business invoicing system;
analyzing the personal financial management and bill payment system user identification data and the business invoicing system payor customer identification data to identify payor users of the personal financial management and bill payment system that are payor customers of business users of the business invoicing system;
identifying a payor user of the personal financial management and bill payment system that is a payor customer of a payee business user of the business invoicing system;
designating the payor user of the personal financial management and bill payment system first payor user of the personal financial management and bill payment system;
providing first payor user of the personal financial management and bill payment system the opportunity to integrate invoices generated by the first payee business user of the business invoicing system into the personal financial management and bill payment system; and
if the first payor user of the personal financial management and bill payment system agrees to integrate invoices generated by the first payee business user of the business invoicing system into the personal financial management and bill payment system, providing the first payee business user of the business invoicing system the capability to provide invoice data representing invoices generated by the first payee business user of the business invoicing system to the first payor user of the personal financial management and bill payment system through the personal financial management and bill payment system.

16. The system for integrating invoice related financial transaction data into a personal financial management and bill payment system to more accurately identify and categorize tax related financial transactions of claim 12 wherein the personal financial management and bill payment system is a financial transaction management and billing system through which a user of the financial transaction management and billing system is provided the capability to categorize financial transactions and pay the user's bills.

17. The system for integrating invoice related financial transaction data into a personal financial management and bill payment system to more accurately identify and categorize tax related financial transactions of claim 12 wherein the additional invoice related financial transaction data includes Level-3 data associated with at least one discrete invoice represented in the invoice related financial transaction data and provides additional transaction details, and/or information, associated with the at least one discrete invoice represented in the invoice related financial transaction data.

18. The system for integrating invoice related financial transaction data into a personal financial management and bill payment system to more accurately identify and categorize tax related financial transactions of claim 12 wherein the additional invoice related financial transaction data includes additional input data to one or more payor users associated with at least one discrete invoice represented in the invoice related financial transaction data of the personal financial management and bill payment system from one or more business payees associated with at least one discrete invoice represented in the invoice related financial transaction data.

19. The system for integrating invoice related financial transaction data into a personal financial management and bill payment system to more accurately identify and categorize tax related financial transactions of claim 12 wherein the additional invoice related financial transaction data includes additional input data from one or more payor users associated with at least one discrete invoice represented in the invoice related financial transaction data of the personal financial management and bill payment system to one or more business payees associated with at least one discrete invoice represented in the invoice related financial transaction data.

20. The system for integrating invoice related financial transaction data into a personal financial management and bill payment system to more accurately identify and categorize tax related financial transactions of claim 12 wherein integrating the invoice related financial transaction data into personal financial management and bill payment system payment due data associated with a personal financial management and bill payment system includes providing the discrete invoices represented in the invoice related financial transaction data as line items in a payment due or other financial transaction listing generated through the personal financial management and bill payment system.

21. The system for integrating invoice related financial transaction data into a personal financial management and bill payment system to more accurately identify and categorize tax related financial transactions of claim 12 wherein processing the portion of the invoice related financial transaction data representing the first discrete invoice as tax related invoice financial transaction data includes providing a copy of the portion of the invoice related financial transaction data representing the first discrete invoice to a tax preparation and filing system for processing as tax related invoice financial transaction data.

22. The system for integrating invoice related financial transaction data into a personal financial management and bill payment system to more accurately identify and categorize tax related financial transactions of claim 12 wherein processing the portion of the invoice related financial transaction data representing the first discrete invoice as tax related invoice financial transaction data includes assigning a tax category to the portion of the invoice related financial transaction data representing the first discrete invoice.

23. A computer program product for integrating invoice related financial transaction data into a personal financial management and bill payment system to more accurately identify and categorize tax related financial transactions, the computer program product including machine readable instructions for implementing a process for integrating invoice related financial transaction data into a personal financial management and bill payment system to more accurately identify and categorize tax related financial transactions, the process for integrating invoice related financial transaction data into a personal financial management and bill payment system to more accurately identify and categorize tax related financial transactions comprising:
obtaining access to invoice related financial transaction data generated by the one or more payee businesses, the invoice related financial transaction data representing two or more discrete invoices submitted by one or more payee businesses requesting payment by one or more payor users of the personal financial management and bill payment system, the invoice related financial transaction data including:
payee business identity data associated with each discrete invoice represented in the invoice related financial transaction data, the payee business identity data representing the identity of the payee business associated with each discrete invoice represented in the invoice related financial transaction data;
payor user identity data associated with each discrete invoice represented in the invoice related financial transaction data, the payor user identity data representing the identity of the payor user associated with each discrete invoice represented in the invoice related financial transaction data;
invoice amount data associated with each discrete invoice represented in the invoice related financial transaction data, the invoice amount data representing the payment amount associated with each discrete invoice represented in the invoice related financial transaction data; and
additional invoice related financial transaction data, the additional invoice related financial transaction data being associated with at least one discrete invoice represented in the invoice related financial transaction data and providing additional transaction details, and/or information, associated with the at least one discrete invoice represented in the invoice related financial transaction data;
integrating the invoice related financial transaction data into personal financial management and bill payment system payment due data associated with a personal financial management and bill payment system, the personal financial management and bill payment system payment due data representing one or more bills associated with one or more users of the personal financial management and bill payment system to be paid through the personal financial management and bill payment system;
obtaining access to the personal financial management and bill payment system;
obtaining access to the personal financial management and bill payment system payment due data, including the integrated invoice related financial transaction data;
obtaining access to additional first invoice related financial transaction data associated with a first discrete invoice represented in the invoice related financial transaction data;
analyzing the additional first invoice related financial transaction data to determine if the first discrete invoice represented in the invoice related financial transaction data is a tax related invoice having potential tax ramifications;
determining that the first discrete invoice represented in the invoice related financial transaction data is a tax related invoice having potential tax ramifications;
transforming first invoice status data associated with the first discrete invoice represented in the invoice related financial transaction data to tax related invoice status data; and
processing the portion of the invoice related financial transaction data representing the first discrete invoice as tax related invoice financial transaction data.

24. The computer program product for integrating invoice related financial transaction data into a personal financial management and bill payment system to more accurately identify and categorize tax related financial transactions of claim 23 wherein obtaining access to invoice related financial transaction data generated by the one or more payee businesses includes:
obtaining access to personal financial management and bill payment system user financial transaction data associated with the personal financial management and bill payment system, the personal financial management and bill payment system user financial transaction data representing financial transactions associated with users of a personal financial management and bill payment system;
analyzing the personal financial management and bill payment system user financial transaction data associated with the first payor user to identify payee data included in the financial transaction data associated with a first payor user, the payee data representing one or more payees associated with first payor user financial transactions associated with the first payor user represented by a portion of the personal financial management and bill payment system user financial transaction data associated with the first payor user;
obtaining access to business invoicing system business user identification data associated with a business invoicing system, the business user identification data representing business users of the business invoicing system;
accessing the payee data and the business user identification data and analyzing the payee data and business user identification data to determine if a payee represented in the payee data matches a business user of the business invoicing system represented in the business user identification data;
identifying a payee represented in the payee data that matches a business user of the business invoicing system represented in the business user identification data, the payee being a payee associated with first financial transaction data representing a first financial transaction included in the personal financial management and bill payment system user financial transaction data associated with the first payor user;
designating the payee represented in the payee data that matches the business user of the business invoicing system as a first payee business;
transforming status data associated with the first financial transaction data representing the first financial transaction to first invoice related financial transaction data;
processing the first invoice related financial transaction data as invoice related financial transaction data; and
providing the first payee business the capability to provide invoicing data representing invoices generated by first payee business to the first payor user of the personal financial management and bill payment system through the personal financial management and bill payment system.

25. The computer program product for integrating invoice related financial transaction data into a personal financial management and bill payment system to more accurately identify and categorize tax related financial transactions of claim 23 wherein obtaining access to invoice related financial transaction data generated by the one or more payee businesses includes:
obtaining access to personal financial management and bill payment system user identification data associated with users of a personal financial management and bill payment system;
obtaining access to invoicing data generated through a business invoicing system, the invoicing data representing invoices sent from payee business users of the business invoicing system to payor customers of the payee business users of the business invoicing system;
monitoring the invoicing data and identifying first invoice data representing an invoice generated by a first payee business user of the business invoicing system associated with a first payor customer of the first payee business user of the business invoicing system;
analyzing the first invoice data to identify first payor customer identification data associated with the first payor customer of the first payee business user of the business invoicing system;
analyzing the personal financial management and bill payment system user identification data and the first payor customer identification data to determine if the first payor customer associated with the first payor customer identification data is a first payor user of the personal financial management and bill payment system; and
if a determination is made that the first payor customer associated with the first payor customer identification data is a first payor user of the personal financial management and bill payment system, designating the first payor customer as a first payor user of the personal financial management and bill payment system;
providing the first payee business user of the business invoicing system the capability to provide invoicing data representing invoices generated by the first payee business user of the business invoicing system to the first payor user of the personal financial management and bill payment system through the personal financial management and bill payment system.

26. The computer program product for integrating invoice related financial transaction data into a personal financial management and bill payment system to more accurately identify and categorize tax related financial transactions of claim 23 wherein obtaining access to invoice related financial transaction data generated by the one or more payee businesses includes:
obtaining access to personal financial management and bill payment system user identification data associated with users of a personal financial management and bill payment system;
obtaining access to business invoicing system payor customer identification data generated through a business invoicing system, the business invoicing system payor customer identification data being associated with payor customers of user payee businesses of a business invoicing system;
analyzing the personal financial management and bill payment system user identification data and the business invoicing system payor customer identification data to identify payor users of the personal financial management and bill payment system that are payor customers of business users of the business invoicing system;
identifying a payor user of the personal financial management and bill payment system that is a payor customer of a payee business user of the business invoicing system;
designating the payor user of the personal financial management and bill payment system first payor user of the personal financial management and bill payment system;
providing first payor user of the personal financial management and bill payment system the opportunity to integrate invoices generated by the first payee business user of the business invoicing system into the personal financial management and bill payment system; and
if the first payor user of the personal financial management and bill payment system agrees to integrate invoices generated by the first payee business user of the business invoicing system into the personal financial management and bill payment system, providing the first payee business user of the business invoicing system the capability to provide invoice data representing invoices generated by the first payee business user of the business invoicing system to the first payor user of the personal financial management and bill payment system through the personal financial management and bill payment system.

27. The computer program product for integrating invoice related financial transaction data into a personal financial management and bill payment system to more accurately identify and categorize tax related financial transactions of claim 23 wherein the personal financial management and bill payment system is a financial transaction management and billing system through which a user of the financial transaction management and billing system is provided the capability to categorize financial transactions and pay the user's bills.

28. The computer program product for integrating invoice related financial transaction data into a personal financial management and bill payment system to more accurately identify and categorize tax related financial transactions of claim 23 wherein the additional invoice related financial transaction data includes Level-3 data associated with at least one discrete invoice represented in the invoice related financial transaction data and provides additional transaction details, and/or information, associated with the at least one discrete invoice represented in the invoice related financial transaction data.

29. The computer program product for integrating invoice related financial transaction data into a personal financial management and bill payment system to more accurately identify and categorize tax related financial transactions of claim 23 wherein the additional invoice related financial transaction data includes additional input data to one or more payor users associated with at least one discrete invoice represented in the invoice related financial transaction data of the personal financial management and bill payment system from one or more business payees associated with at least one discrete invoice represented in the invoice related financial transaction data.

30. The computer program product for integrating invoice related financial transaction data into a personal financial management and bill payment system to more accurately identify and categorize tax related financial transactions of claim 23 wherein the additional invoice related financial transaction data includes additional input data from one or more payor users associated with at least one discrete invoice represented in the invoice related financial transaction data of the personal financial management and bill payment system to one or more business payees associated with at least one discrete invoice represented in the invoice related financial transaction data.

31. The computer program product for integrating invoice related financial transaction data into a personal financial management and bill payment system to more accurately identify and categorize tax related financial transactions of claim 23 wherein integrating the invoice related financial transaction data into personal financial management and bill payment system payment due data associated with a personal financial management and bill payment system includes providing the discrete invoices represented in the invoice related financial transaction data as line items in a payment due or other financial transaction listing generated through the personal financial management and bill payment system.

32. The computer program product for integrating invoice related financial transaction data into a personal financial management and bill payment system to more accurately identify and categorize tax related financial transactions of claim 23 wherein processing the portion of the invoice related financial transaction data representing the first discrete invoice as tax related invoice financial transaction data includes providing a copy of the portion of the invoice related financial transaction data representing the first discrete invoice to a tax preparation and filing system for processing as tax related invoice financial transaction data.

33. The computer program product for integrating invoice related financial transaction data into a personal financial management and bill payment system to more accurately identify and categorize tax related financial transactions of claim 23 wherein processing the portion of the invoice related financial transaction data representing the first discrete invoice as tax related invoice financial transaction data includes assigning a tax category to the portion of the invoice related financial transaction data representing the first discrete invoice.
